(19) United States
(12) Patent Application Publication
(10) Pub. No.: US 2002/0133325 A1
(43) Pub. Date: Sep. 19, 2002

(54) Discrete event simulator

(76) Inventors: Raymond R. Hoare II, Pittsburgh, PA (US); Jiyong Ahn, Pittsburgh, PA (US); Jesse Graves, Pittsburgh, PA (US)

Correspondence Address: {Atty/Agent}, REED SMITH LLP, P.O. Box 488, Pittsburgh, PA, 15230-0488, US

(21) Appl. No.: 10/043,847

(22) Filed: Jan. 11, 2002

Related U.S. Application Data
(60) Provisional application No. 60/267,529, filed on Feb. 9, 2001.

(51) Int. Cl. G06G 7/62

(52) U.S. Cl. 703/17

(57) ABSTRACT

A system and method for the simulation of discrete events. Events can be defined or mapped from Boolean logic, finite equations, lookup tables, emulation of processors, or may be algebraic in nature. An event-based simulation scheme with single-memory word representation of event models and timing is described. Event models are instantiated in parallel simulator engines (logic, behavioral, soft-emulation, memory, processor, interconnection, and/or any combination of these). A central scheduler minimizes computation time traditionally spent on sorting chronology and sequence of events as the events propagate through models and interconnections or links, with the scheduler interfaced to each engine via dedicated pipelined communications channels. The scheduler simultaneously serves pending events to simulation engines for evaluation and retrieves future events from these engines for sorting and resubmitting for further simulation. The simulator scheduler addresses simulator cycle time management, sub-cycle event handling (new pending events), and the recording of results. The capacity of simulator preferably exceeds multi-millions of models and the computational speed approaches multi-millions of events per second.

This application claims priority to the earlier filing date of U.S. Provisional Patent Application No. 60/267,529 filed on Feb. 9, 2001.

### BACKGROUND OF THE INVENTION

1. Field of the Invention

The present invention relates to systems and methods for simulating discrete events, and, more specifically, the present invention relates to computer-based simulators capable of simulating many different event-based scenarios.

2. Description of the Background

In the growing digital world, discrete events can be found almost everywhere. Because of the combinatorial nature of such discrete events (e.g., on/off, 0/1, high/low, inside/outside limit range, step/no-step distance increment), it is often desirable to combine them algebraically into a library of models. More specifically, whether discussing computer chip functionality or troop movements, the models are the minimum activity that occurs in the scenario, and thus many of such models are “interconnected” to create the complete simulation.

In a traffic simulation, examples of these event-based models may include a traffic light, a vehicle, a road, an intersection, and/or an obstruction. Thus, in describing the overall scenario, all the models are figuratively connected in an algebraic combinatorial sense. The simulation “machine” works by computing the discrete events of a vehicle starting and accelerating, a traffic light turning red, and so forth as applied to the interconnected model topology, map, or network. Similarly, in a computer chip simulation, this minimum model may be a logic gate. Chip simulation is the computation of serial and parallel events as they ripple through the logic gate interconnections, much like the vehicles running through a traffic model map. It is valuable to simulate any of these scenarios because it is possible to predict system performance and detect design flaws. Simulation of discrete events predicts scenario behavior before physically building the actual design.

The actual value of the simulator, however, is evaluated based on the speed at which the models and simulation are set up in the simulation machine (weeks to months may be practical), the speed at which the simulation itself executes (minutes, hours, or days may be practical), and/or the speed at which the computational result is understandable by the simulation operators. The present invention, with purpose-design hardware and software, preferably decreases one of more of these times in relation to conventional systems by one or two orders of magnitudes.

Discrete event simulation, based on a library of event models, is a way of simulating or characterizing cause-effect events that can be described as occurring at one particular moment in time—a discrete event. These events are not continuous and have finite result outputs that are selected from a group of available outputs or calculated based on the inputs. Simply stated, a model, as introduced above, has inputs or “causes,” and has resulting outputs or “effects.”

Since discrete event simulation applies to a host of applications from battlefield simulation to human interaction, it is important to recognize that the internal classes of the model cores (see e.g., FIG. 4A) can be: (a) a simple to complex truth table; (b) a lookup; (c) a reduction to finite conclusion of a continuous or transient equation; (d) a re-modelable or re-programmable core-processor; (e) a software emulated core within the model; and/or (f) a hardware emulated core. The present invention preferably employs means to support all these and additional classes.

Historically, large models and model “maps” break conventional computer architectures. The cores of the models are practical only if the overall simulation machine can simulate and resolve the targeted scenario in a reasonable time as noted above. Generally speaking, if the constituent events can be made discrete, the process can be simulated using a discrete event simulator. However, conventional discrete event simulators generally can handle only the simplest model cores because their inherent architectures are inefficient when thousands to millions of models are employed (simulations take months to years to resolve).

In at least one embodiment, the present invention enables streamlined, compact, “minimal” cores of any of the (a) to (f) classes mentioned above such that the cores are preferably: (1) efficient to interconnect; (2) efficient to compute and sequentially resolve by magnitude time improvements over prior art; and (3) efficient in occupying simulator topology, map, or other interconnection scheme, whether integral to the simulator, external as an emulated extension, or embedded as a single or multiple co-simulated (simulator within or enjoined simulator) memory space.

Once models are loaded and interconnected in the simulator, the discrete event simulation execution process is generally broken up into three processes: evaluation of state in the current cycle (number i); update of the models and map or topology; and scheduling of the next evaluation step (i+1). In any given scenario, the simulator at the starting time t=0 applies the first events and/or initial conditions to the models.

The concept of “time” during execution is important in simulation. The discrete event simulator must compute faster than the propagation time of models. The simulator increments its internal timekeeper a small increment, and checks if any of the models have produced an output, change, or other “effect.” In any discrete event simulator, the time increment value is or should be significantly smaller than the smallest time needed for a model to change and to propagate the model's change to other models to which it is connected. At a high level view, as the models react to initial conditions and events, the simulation “ripples” model events through the topology to a conclusion. As this rippling resolves, the timekeeper of the simulation is watching at a subinterval time.

For example, if ten models were connected in a simple serial map, and if an event at the start of the serial path were to induce changes all the way through the map, and each model required 1 second itself to propagate a change, then the overall map requires 10 seconds to resolve. A discrete event simulator's timekeeper would be set at a fraction (the faster the better) of 1 second. On every tick of the timekeeper's clock, the simulator detects the occurrence of any output. In this example, if the time step were 0.1 second, then the event simulator would be able to detect if any model really changed with at best 1.0+/−0.1 seconds accuracy. In chip simulation, timesteps typically shrink to a few picoseconds (10⁻¹² second) and gate models run as fast as several hundred picoseconds.

Since real world scenarios are being predicted with discrete event simulation, and since real world equivalents of models (vehicles, logic gates, gears) have inherent variability that in best and worst case all aggregate to a working or non-working state, it is critical that the simulator have significant accuracy to measure: (1) the function of the model; (2) the propagation timing of the model; and (3) the propagation and time of interconnections of the models in the topology. Without such accuracy, the validity of the simulation is in question.

A model of the discrete event system is evaluated, based on a change in one or more of its inputs, which may or may not change one or more of the component's outputs. In the update process, the new output values are stored and “future events” are generated based on other system models connected to the output of the model being evaluated. All of these future events, which are time-stamped to be evaluated at some point in time in the future, are then put into chronological order by a scheduling function. As the time for evaluation of a future events comes due, this “pending” event will then be evaluated. In a simple case, with reference to FIG. 4B, if all inputs or “causes” are presented to Event 1, the evaluation phase at time t=0 includes computing the value of G and (using the state of G at time 0) of H. G is the result of the function g(a,b,c), and H is the result of function f(d,e,f). Within each of these functions can be a logic gate, a finite linear equation (e.g., for traffic or logistical analysis), a finite ordering-with-rules task, and/or any other model described above. If functions g(a,b,c) or f(d,e,f) are based on continuous ranges of their variables, then for the overall simulation, G and H must have a finite and discrete map or transformation. In any case, each Event is evaluated at time t=0, then at time t=1, time t=2, etc. The time steps of cycles can be in picoseconds, seconds, minutes or any other step valve as appropriate to the technology; the criteria is that cycle time is less than the shortest event. At each time step, the map, which in principal represents the connections between events, is updated in the simulator. Results are then passed to a scheduling mechanism. In the case of FIG. 4B, scheduling is simple.

The case of FIG. 4C is not as simple, and it suggests why scheduling plays an important role. At time t=0, a complexity exists for conventional simulators in that the W result at time t=0 affects both the outcomes of G and H in time t=0 and subsequent time steps. In the evaluation process, attention must be given to such “conditional” events. These conditional events really amount to “sub-cycle pending events.” In FIG. 4C, (assuming W has an initial, computable condition), G is the result of G(W,b,c), and H is the result of f(G,e,W). However, if W changes quickly and before time step t=1 occurs, the simulation must account for the sub-cycle event of W, and recompute G (and thus H) within the same overall cycle. In general, if computation of even one event can influence the concurrent value or state of another event within the same cycle, a mechanism must “re-evaluate” and repropagate conditional events within the ith cycle before the simulation proceeds to the i+1 cycle, or the simulator is not truly asynchronous and may be prone to mishandling sub-cycle events. The present invention preferably handles all sub-cycle events directly on the engines, and the scheduler thus never sees them. The scheduler only sees “future events.” The method employed in the invention is simply to maintain a very fast clock cycle that has ten to one-hundred times more resolution than the fastest event. With a sufficiently small timing granularity, the invention simulator preferably never encounters a need to re-evaluate.

For every ith cycle, after scheduling, the simulator represents the final, “rippled,” and sorted ith cycle result to be computed in the next i+1 cycle. The process then loops back to the evaluation phase, but with discriminate logging of results on a wholescale, selected, or “upon selected event or events” or other, for every or any input or output of a model and for every interconnection that implies time-delay or other modeled constraint. In logic simulation, the last item includes but is not limited to lumped capacitance, power dissipation, and/or model output contention.

For much of this discussion, the simulation of logic Integrated Circuit (IC) gates are the working example. Discrete event IC logic simulation typically involves both the functional logic level and the timing propagation (of gates and “wires”) simulation of digital integrated circuits at the gate level. For a digital circuit, the simplest building block is the gate, e.g., “AND's,” “OR's” and “NOT's.” From FIGS. 4A, 4B, and 4C, events shown are equivalent to gates, and the arrows represent the wires or metal substrate connections that cascade the gates. Even though digital logic simulation is discussed in the examples, it is useful to restate that Events 1, 2, and 3 can easily represent most discrete functions and conditional behaviors.

For simulating a variety of different circuits, weather patterns, or other discrete systems, a library of “event model sets” is considered part of the simulator. A topology “interconnects” these event models such that a finite and resolvable sequencing can be computed. In FIG. 5A, the diagram suggests three models, events E1, E2 and E3, for a library. This library could contain hundreds to millions of other event models. These models are the elements that are individually computed in the evaluation phase. The interconnections of these models is the map or topology in the memory update phase that is updated each simulation cycle, and the simulator's scheduling method resubmits conditional and complete events for the next time cycle. Thus, the truth tables, finite or discrete equations, or other transformations that are inside each model are the smallest “computable” element in the simulator.

In the IC simulation case, as microprocessors and other computer hardware components increase in speed and the amount of data that can be processed, the integrated circuit designs involve increasing numbers of logic elements. All of these elements need to be properly tested and simulated to determine whether or not the design is useful for its intended purpose.

Additionally, heat and noise characteristics of the circuit can be determined based on the frequency of state change of circuit components. As an increasing number of logic elements are used, the computing power necessary to simulate these circuits increases rapidly.

In the general discrete event world case, the same issues of: (1) how realistic the models are and how many models can be interconnected in one simulation session; (2) the speed of the simulation; and (3) the accuracy of the simulated result exist and must be practically addressed.

Both in IC simulation and in the more general discrete event case, conventional discrete event simulation machines often have been limited because of: an implementation using modeling schemes that exceed practical computer memory (or speed of the memory used—a disk is large but very slow compared to RAM memory); the speed of resolving event propagation and interconnection of a single model, let alone millions of models; boftlenecked internal communications that are to pass events and results from cycle to cycle; inefficient machine elements that spend most of their time sorting and scheduling such that as the model topology increases, execution time increases geometrically; and constraints where simulation results when recorded significantly slow-down execution processes. Lastly, conventional systems typically also require long development times (months to years) to create model libraries.

Historically, simulation engines have been software-based or have been based on hardware emulators, which employ a simplified functional replica of the circuit. Usually these replicas are incomplete as model sets because all the real behavior of the model, such as timing, cannot be varied or observed. These two simulation methods employ libraries of gate elements that are interconnected in a circuit model map that represents the physical, designed IC. These maps of models are generically called “net-lists.” The problem with these two engines cited is that as the number of gates and wire interconnections increases, these simulators and emulators are unable to contain the net-lists and are unable to simulate the circuits in an acceptable amount of time (often taking months to simulate a complex circuit). The present invention may contain ten to fifty times the number of models as the conventional systems, and it may simulate events 400 to 1000 times faster (in real time, not in machine cycles).

In the general discrete event simulation case, a conventional simulator implementation may use a backplane of ten to twenty general purpose “off-the-shelf” computer modules. These modules interconnect with conventional SCSI, parallel, Ethernet, or similar communications components. A general purpose workstation is typically used to control the modules, loading the model map into conventional (off-the-shelf general purpose) memory with the typical performance of a fast personal computer. The execution process is run by the modules. However, the modules as a parallel architecture are limited by the communications, and thus cycle time is wasted as all the modules “catch-up” with each other and re-synchronize for scheduling. Since the modules are general purpose in design, more than half to two thirds of the total simulation time may be spent in scheduling. The present invention employs a unique purpose-designed scheduler mechanism and parallelism solution that, in at least some embodiments, reduces this to under ten percent of the total time. Further, as the simulation operator makes increased numbers of requests for the results of simulation, the overall simulation time increases geometrically. These constraints are typical of a general purpose implementation, even when emulation is used in an “assist” manner. The present invention's architecture preferably addresses this “user interface” limitation.

More recently in the logic simulation case, emulators have used an increasing amount of computer hardware to simulate integrated circuits. For example, many programmable devices, running in parallel, can be used to evaluate various gates in parallel. Many of these parallel tools lack a realistic method of handling “backup and re-evaluate.” Emulators effectively replace the map or topology of models with literal copies or physical replicas. Using such, the emulation is only as realistic as the replicas. Usually, replicas do not allow thorough timing analysis in the simulation because the replicas have but only one timing value, as do their connections (they are not technology-specific).

Lost through model inaccuracy and constrained-by-scheduling/backup parallelism, the emulator has been useful for basic (under 15 million model) functional simulation. These systems use general purpose programmable devices and processors that are programmed for simulation. As such, these systems are not optimally efficient for the geometrically increasing (by number of connections) event propagation communication, update of, and access to the memory containing the map or topology, and scheduling processes carried out in the simulator. Further, real-life timing and wire delay and wire interference (i.e. crosstalk) are nearly impossible to include in, or even model, because of conventional computer or memory limitations.

It is important to note that applications other than digital logic simulation suffer from the same computation and memory limitations. With weather modeling, traffic-light timing optimization, troop movements, and so on, being very representable as a library of interconnectable “cause-event” elements and conditional event possibilities, the present invention provides similar advantages.

The various limitations to the current discrete event simulation and emulation engines are preferably addressed by one or more preferred embodiments of the present invention. These and other objects and advantages of the present invention will become readily apparent to persons skilled in the art from the following description of particularly preferred embodiments.

### SUMMARY OF THE INVENTION

In at least one presently preferred embodiment, the present invention provides a computer-based simulator capable of simulating many different event-based scenarios such as (a) to validate computer chip operation, (b) to optimize traffic and logistical flow ranging from parcel delivery to soldier movements, (c) behavior of mechanical and molecular models, and (d) to assist in weather modeling. It is a discrete event simulator that computes any of these scenario's outcomes based on causes and effects. This is a faster approach to simulation than by use of a free-running or continuous time clock. In the time clock case, a lot of time is wasted computing no activity between the scenario's real events. Discrete event simulators have existed prior but have been built on traditional computer architectures and components. This invention is unique and novel because it employs new methods and means to compute outcomes many hundreds of times faster than the prior art.

The invention's modeling methodology may be based on a specific optimization algorithm for defining, compacting and making models memory-efficient—in terms of memory space and memory execution. The models in the invention are generically called “primitive elements,” or “primitives”. The present algorithm allows for hundreds of millions of primitives and interconnections (with a high average of ten, or a typical average interconnection being five connections or less) to be contained in the memory of simulation processors in parallel during execution.

The system further may be characterized by a specific mechanism to instantiate these primitives and associated interconnections as a complete or partitioned topology into the memories of parallel components (see above). This specific mechanism creates an ability to rapidly probe, modify, and insert manual override (e.g., insert faults, force values) in the net-list topology before, during, and after simulation execution.

These systems and methods are generally characterized by one or more discrete event simulation engines that are interconnected to a central scheduler with purpose-designed parallel gigabit conduit intercommunication. This central scheduler that evaluates discrete events is capable of sorting the events sequentially and maintaining accurate “backup” and update requirements as defined in the model and map of interconnections. The discrete event simulation engines may be used to simulate a wide array of discrete events. One particularly useful technology field involves the simulation of digital logic circuits. If a library of other cause-event models are described and implemented, the invention can simulate the events and inter-event conditions and timing.

The present invention generally comprises: an event scheduler; one or more simulation (evaluation) engines; and direct input and output data queues between the scheduler and each of the simulation engines. These queues get and pass data through purpose-designed conduits that interconnect the scheduler and simulation engines.

The scheduler accepts all incoming (future) discrete events from the simulation engines and sorts them into chronological order as they are received. When the system determines that scheduled events are to be evaluated, these (now) “pending” events are queued to the one or more simulation engines for evaluation. Based on a change of state during this evaluation process, one or more future events are created by the simulation engines and are transferred to the scheduler for sorting and sending. The scheduler preferably keeps track of when to send pending events based on a virtual “simulation time” that represents time within the system that is being simulated.

One exemplary simulation engine is a primitive simulation engine capable of evaluating gate-level logic and primitives. Preferably, this simulation engine includes dual ported memory and a pipelined evaluation block that allows multiple pending events to be continuously evaluated within one (or a few) clock cycles of each other. The evaluation engine accepts the incoming pending events from the pending event queue, looks up information about the gate referenced by the pending event in a local memory, updates the gate information based on the evaluation of the gate, creates future events based on other gates that are connected to the gate that is currently being evaluated, and stores the current gate's updated status back into memory.

A second exemplary simulation engine is a memory simulation engine. The memory simulation engine preferably combines emulation and simulation techniques to allow for the accurate functional and timing modeling of various memory access functions. Preferably, this simulation engine includes both regular random access or read-only memory and content addressable or other similar lookup memory.

A third exemplary simulation engine preferably simulates behavioral circuits and software algorithms, including discrete transformations of continuous and transient equations. This behavioral simulation engine stores functional descriptions of circuit behavior and timing to allow for the simulation based on changed inputs. It may be useful for modeling “analog,” equation-based, soft-emulation, lookup with hard-emulation, or intellectual property (IP) blocks that are manufactured by third party vendors.

A fourth exemplary simulation engine is an interconnection and net-list/annotation simulation engine which embodies algorithms to facilitate faster single or in parallel processing of model topologies, interconnection timing or other influences (e.g., impairments such as crosstalk, contention) and facilitates rapid processing of physical annotation and lookup of individual model connections (“nets”) and interconnection properties.

The discrete event simulators of the present invention may include any combination of the above or other simulation engines (or more than one of any single type of engine) to simulate discrete events. If the evaluation functions of the simulation engines are separated from the scheduling function of the scheduler, then a simplified architecture with removable/expandable simulation engines may be used. The future events need only contain updated input values and an identifier (model-ID) which references a structure within the simulation engine. The appropriate simulation engine can then decode the pending event, re-evaluate the gate it references, and create applicable future events with time stamps and updated input characteristics to be scheduled by the scheduler.

The system may also include wider than traditional memories to allow for single clock cycle access to large blocks of stored data and an insert sorting scheduler capable of putting future events in sequential order in only 2-3 clock cycles, while the system is operating.

The system may also include various simulation control and logging/results functions that allow for the monitoring of (a) the occurrence of, or frequency of model state/value changes, (b) indirect characteristics owing to simulation behavior such as heat, noise generated, susceptibility, congestion, and (c) various types of fault insertion and consequence monitoring. These facilities may be included within the scheduler, primitive and other engines, and/or pipeline conduits to allow for fast action without intervention (which would slow overall simulation) by the operator's user interface device.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a general over view of a discrete event simulation system;

FIG. 2 is a general process outline for a discrete event simulation system;

FIG. 3 details an algorithm for applying the present invention to the simulation of computer integrated circuits;

FIG. 4 details the relationship between elements and models wherein 4A shows exemplary models and 4B and 4C show simple and conditional event topologies respectively;

FIG. 5 shows an exemplary circuit to be simulated including conventional integrated circuit gates (5A) and a circuit including a behavioral modeled element (5B);

FIG. 6 is an exemplary embodiment of the present invention as a simulator with three simulation engines;

FIG. 7 is a block diagram of an exemplary logic/primitive simulation engine;

FIG. 8 is a block diagram of an exemplary memory simulation engine;

FIG. 9 is a block diagram of a net engine in various configurations (9A-9C);

FIG. 10 is a block diagram of an exemplary scheduler;

FIG. 11 details the primary functions of the scheduler in chronological steps (11A-11D);

FIG. 12 is a representation of timing wheels used to manage pending and future events during simulation; and

FIG. 13 shows an exemplary logic circuit (13A) and its corresponding emulation-delay representation (13B).

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

The present discrete event simulator may be used in many different fields in which the simulation of discrete events is necessary or desired. The vast variety of events in daily life that can be characterized to include finite (discrete) outputs selected from a predefined list make discrete event simulation useful across many technical and non-technical fields.

Regardless of the field of use, the basic structure of the present system and methodology remains the same: removing the event scheduling processes from the event evaluation processes. To better detail the advantages and operation of the present discrete event simulator, a particular finite example will now be given.

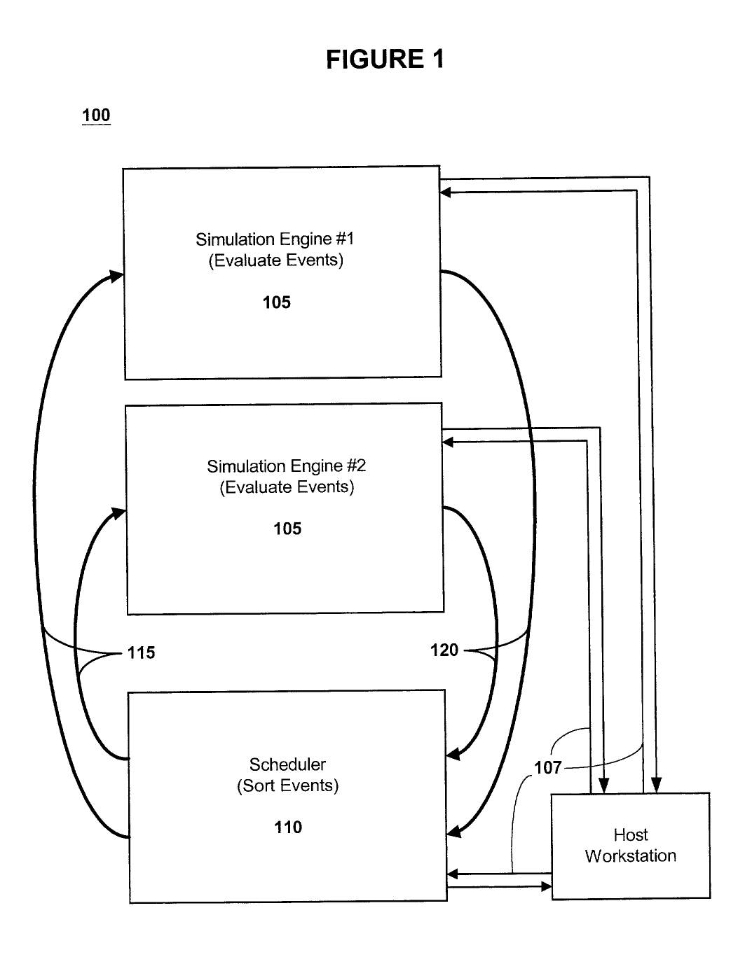

As seen in FIG. 1, one or more simulation (evaluation) engines 105 may be directly connected to a remote scheduler 110 via a communications media, such as input queues 115 and output queues 120. The scheduler 110 receives events that have yet to be evaluated and sorts these events into chronological order. As the scheduler 110 increments “simulation time” within the system being simulated, the group of sorted events that fall within the current time increment are released to the one or more simulation engines 105 as “pending events” over input queues 115. These pending events identify or refer to a structure within the system being simulated, and the pending event also includes information about a change to be made to this structure (e.g., a change in the state of an input pin to a logic device).

The simulation engine 105 to which the pending event is directed will accept the event from the pending event queue 115, retrieve the referenced structure from a local memory, re-evaluate the event based on the change, and generate new future events based on other system structures that are connected to the output of the current structure. These future events are time-stamped to indicate at what point in the future they should be evaluated. The future events are sent to the scheduler 110 via an output or future event queue 120 where they are sorted “on-the-fly,” preferably using data pointers and wide memories are described more fully below.

By removing the scheduling process from the evaluation process, many different inefficiencies can be designed out of the simulator system 100. Also, by adding new and different simulation engines 105, events of an almost limitless variety can be simulated using the same general simulation system structure 100. Additional engines 105 of the same kind can also be used to process multiple events at once. This scalability is desired.

FIG. 1 also shows a host workstation connected to each of the simulation engines and the scheduler by way of a bus or direct connection 107. This host workstation preferably interacts with each of the system components to provide a convenient interface between the simulator and the operator of the simulator. The workstation may be used to input the system to be simulated into the simulator, to monitor various aspects of the system during simulation, and a for various other functions.

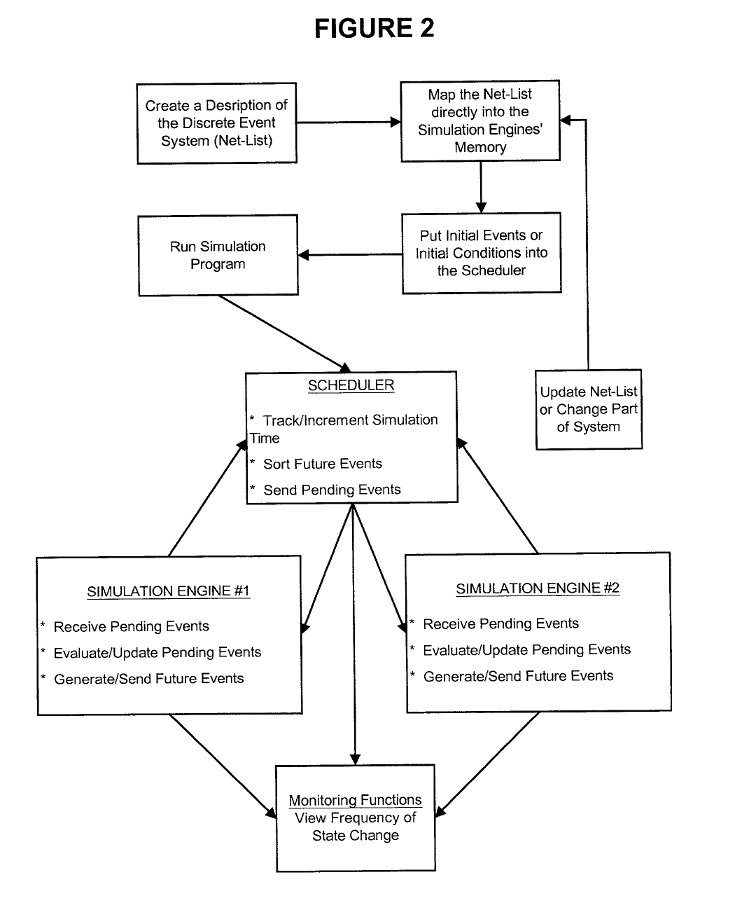

To simulate a discrete event system using the simulator 100 of the present invention, a methodology such as that shown in the flowchart of FIG. 2 is preferably carried out. Initially, the real-world discrete event system must be analyzed and converted into a functional description of the system. Each component of the system must be isolated, and the interconnections between each of the components must be determined. These component descriptions should include not only what happens functionally to the output of a component when presented with a certain group of inputs, but should also include any timing information about how long it takes for the system component to change state.

The primitives are specifically structured and “packaged” according to an algorithm to contain these essential yet complete descriptions such that the simulation engines (described above) need not encounter overhead as the evaluation process proceeds. This compact and computationally fast algorithmic method creates primitives that consume minimal memory and execute in typically one machine cycle to as few as less than ten. These primitives follow the wide geometry of the simulation engine memories so that as few cycles as possible are needed.

The resulting description of the circuit may generally be referred to as a “net-list.” This net-list is then divided up into subgroups of components based on the type of simulation engine that will be used to evaluate the component. For example, if the discrete event simulator 100 includes two type A simulation engines and three type B simulation engines (where A and B refer to types described above), then the net-list must be parsed into not only type A and type B components, but also into which of the type A and type B components will be evaluated by which of the appropriate simulation engines. Once this determination is made, the components are preferably directly mapped into the correct simulation engine. This mapping may take the form of storing a description of the current component's state (including component identification number, input values, current output state, connection information, internal state, and timing information) directly into a computer memory located in the appropriate simulation engine.

Before the simulator can be started, the primitives are instantiated into engine memory with interconnections. Thereafter, initial state conditions, input conditions or other events are preferably put into the scheduler to define how the discrete system is set up. FIG. 1 shows a host workstation connected to the scheduler and each simulation engines by a bus or direct connection. This host computer is preferably capable of inputting information into the simulator as well as monitoring run-time and post run information at various parts of the simulator. After input, the simulator can then be run, and the first of the initial events (pending events) can be sent to the appropriate simulation engines.

The scheduler and engine processing includes mechanisms to facilitate logging of results by step, cycle, by model-ID or-IDs, “on occurrence” triggered, etc., and any combination thereof, for review as the simulator pipelines these results to a user interface device or workstation, or after the simulation is run to its conclusion. This same facility can interrupt the simulation and post results immediately or pass results to another application; for example if the operator requests an “on-occurrence” event, the scheduler and engines know to stop when this event occurs. With this, user flexibility the simulator can be run and rerun while retaining the same, original instance of the net-list.

The rest of the flow chart shows how the functionality of the simulation engines and scheduler can operate simultaneously. The scheduler receives and sorts incoming future events from the simulation engines, keeps track of the current local simulation time, and sends pending events directly out to the simulation engines based on the current simulation time.

The simulation engines receive these pending events, evaluate and update the stored descriptions of the components based on the changed conditions referenced in the received pending events, and generate future events that are to be evaluated at some point in the future based on a change in the state of the component currently being evaluated. These future events are sent to the scheduler as they are created. Multiple simulation engines (and even multiple tightly or loosely coupled schedulers) may operate simultaneously.

While the above operations occur, there may also be external means to view characteristics of the various stored components in the simulation engines. For example, the number and frequency of state changes of a component in a simulation engine can be used to determine the heat and noise characteristics of a particular part of the simulated system (if those characteristics are applicable to the system being simulated). These monitoring functions preferably operate while the simulator runs.

There may also be the ability to update or change one or more system components while the system is running or with little down time. For example, if the monitoring function reveals a design fault in the circuit, the update function may allow the incorrect gates to be changed and the simulation to continue with little or no down time. This is advantageous when a complex simulation is undertaken.

Updating or changing one or more model-IDs in this manner allows “on-the-fly” design changes and high performance fault modeling and input stimulus “grading,” where the simulator is able to compute the statistical omission of an input stimulus “not flushing out” a fault in the topology net-list, thereby failing to detect a design flaw. Such flaws are not detectable unless the input stimulus causes the flaw to propagate to an observed output.

The above description outlines the general system and methodology for a discrete event simulator according to at least one preferred embodiment of the present invention. Although the simulator may be used in many different applications, the following concrete example is provided to more particularly point out particular features and advantages of the present invention.

One important field of use of the present invention is in the design and simulation of very large scale integrated (VLSI) electronic circuits. The software used in the process of designing, simulating, and synthesizing an electronic circuit layout for fabrication is known as electronic design automation (EDA) software. Logic simulation is one of the fields in EDA that the hardware designers depend on for verification and gate-level timing analysis. In order to understand some of the features and concepts of present invention, additional information about discrete events and logic simulation is necessary and will now be provided.

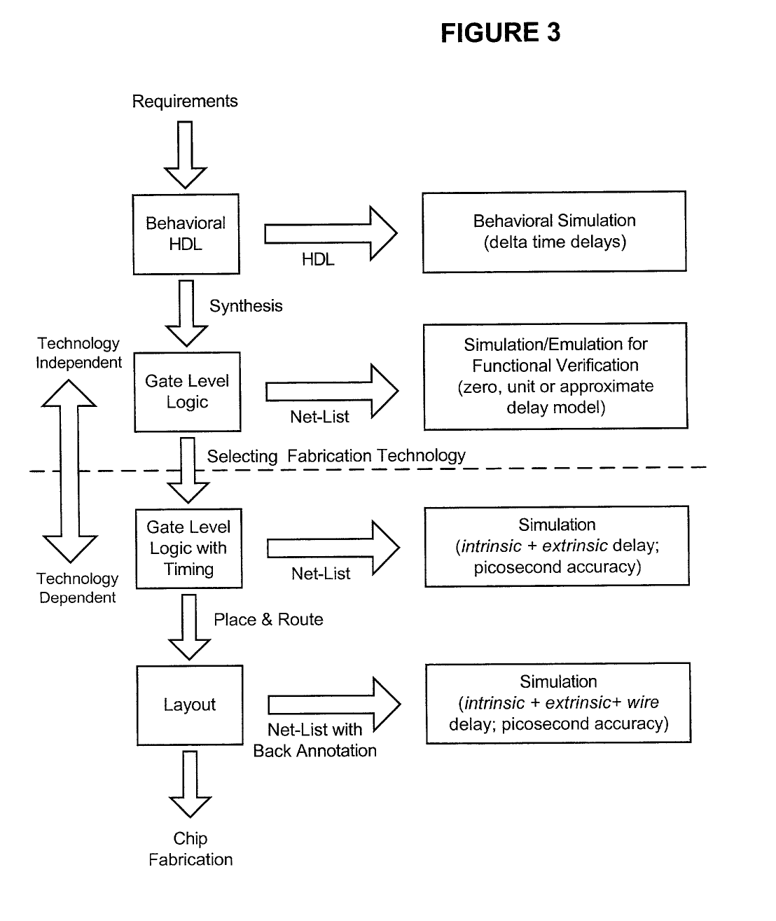

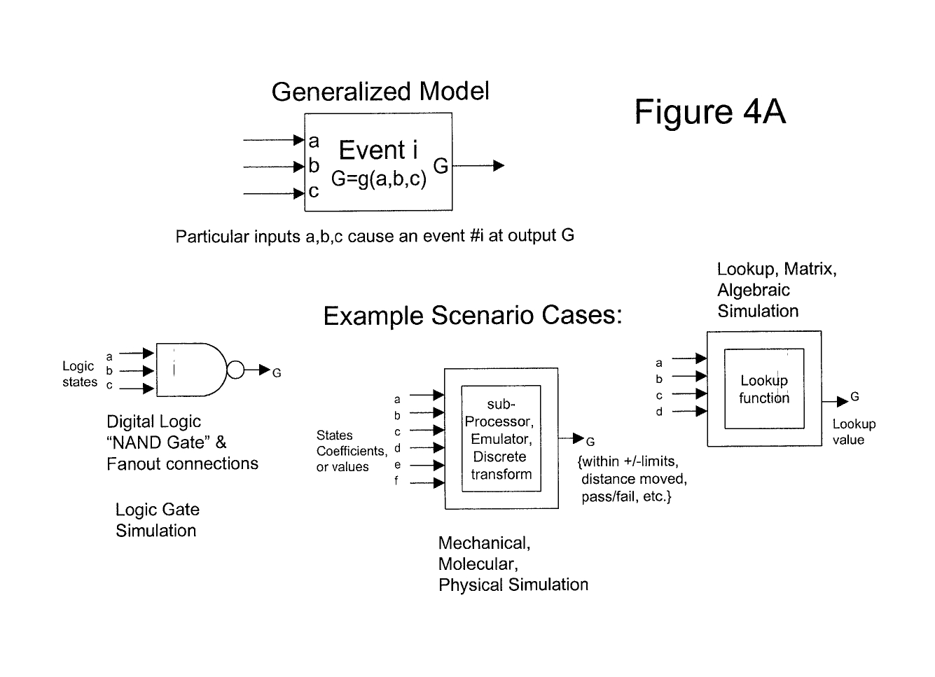

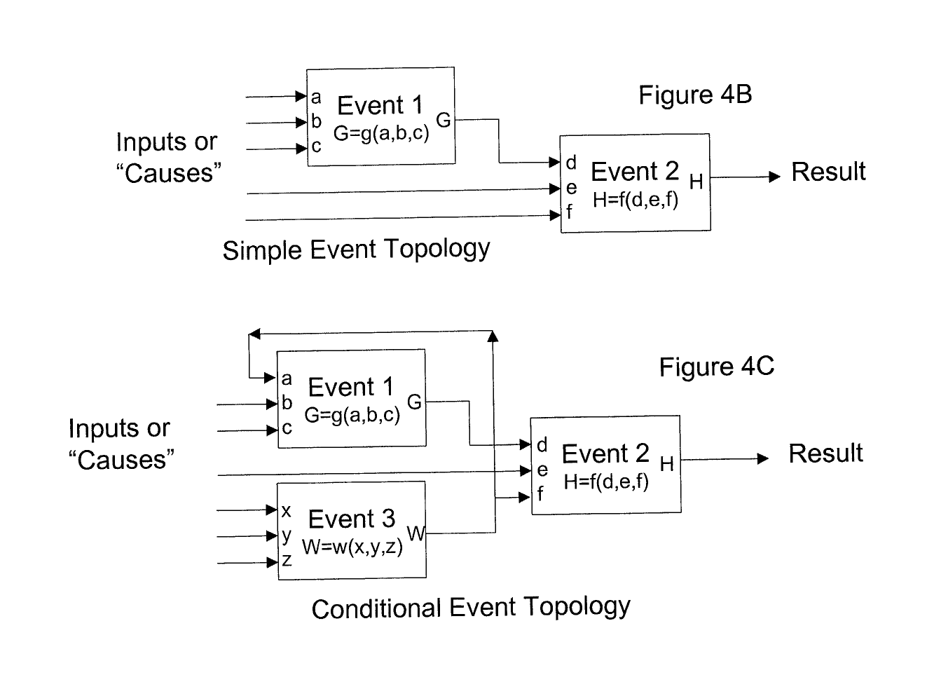

As integrated circuits become more complex, often utilizing many millions of transistors, designers typically rely on logic simulation to verify the design's accuracy at the various levels of abstraction. Logic (i.e., gate) level simulation is the preferred level for designers to test their designs because levels higher than the logic level (e.g., register transfer level) are not accurate enough to extract the performance of the design and the level below the logic level (transistor level) requires too much computing time to be practical. For various purposes, designers may simulate their design before they synthesize the design (pre-synthesis simulation), after the design has been synthesized (post-synthesis simulation), after the design has been synthesized and mapped to a fabrication technology (postsynthesis, post-technology mapping simulation), and/or after the gates have been placed in particular locations on the designed chip (post place-and-route). The present invention may be used at any point in the design cycle. FIG. 3 shows these various stages of circuit design.

Pre-synthesis simulation typically utilizes a hardware description language (HDL) such as VHDL or Verilog to describe the circuit to be simulated. Simulation at this level uses a delta-delay model that assumes that the gate delays are a delta-time that is small enough so as to be ignored except in the ordering of events. Wires delays (between successive circuit elements) and gate delays (through the gate during evaluation) are generally ignored. These assumptions greatly increase the speed of simulation, but they do not produce a simulation of the design which includes accurate timing information. This level of simulation is therefore only used to verify the accuracy of high-level design and control mechanisms.

As shown in FIG. 3, synthesis transforms the HDL into a gate level description of the circuit. This design step is often lengthy as a single line of HDL code may be synthesized into hundreds of gates (e.g., arithmetic operations). However, at the gate level, there is a one-to-one relationship between each gate and its standard cell layout. Each gate or flip-flop represents between approximately two and fifty transistors, but the layout of these groupings of transistors is known. Thus, once a design is simulated at the gate level, a particular fabrication technology can be specified and accurate timing information can be achieved.

Before a fabrication technology is chosen, the circuit's functional behavior may be emulated. In this design phase, the gate level design is mapped into a reconfigurable architecture (a Programmable Logic Device (PLD) such as a Field Programmable Gate Array (FPGA)) that emulates the circuits behavior. Emulation can be used to verify the functional behavior of a circuit, but it does not accurately represent the actual timing of the circuit because emulation is technology independent.

Gate level simulation can also be used to determine the functional behavior of a circuit, but it may be slower than emulation because it incorporates technology-specific gate delays (or approximations of the gate delays) to determine a circuit's behavior. Gate level simulation sacrifices simulation speed in order to achieve greater accuracy, especially in timing. This level of simulation is useful in determining the technology that is required for each level of circuit performance.

After the circuit's functional behavior is verified and after a technology is chosen, the location of each gate within the circuit is determined. This phase is called “place-and-route” because each gate's VLSI implementation is placed within the chip area, and wires are routed among the different gates to implement the specified circuit. After this phase is performed, the wire delay between the gates may be incorporated into the simulation. At this point, the timing of the circuit can be estimated down to picoseconds (10⁻¹² seconds) or below. The problem with simulating gates at this level of accuracy is performance. Traditional zero-delay gate simulators fail here.

Recent design processes rely on a software-based logic simulator running on a high performance workstation. Advanced processor and system architectures with generous amounts of memory can increase the performance of logic simulation to a degree, but the performance eventually hits a barrier due to a memory access bottleneck and inefficiencies due to the workstation's general purpose design.

For gate level simulation, circuits are described in terms of primitive logic gates (or groups of primitives joined as macros) and their connectivity information. Such gate level circuit descriptions are called “net-lists” because they describe a network of interconnected gates. The primitive logic gates are typically evaluated by a table look-up or by calling a software function.

There are two main categories of algorithms in logic simulation: the compiled approach and the discrete event-driven approach. To determine the logic behavior of a circuit, the compiled approach transforms the net-list into a series of executable machine-level instructions. Since the arithmetic logic unit (ALU) of a general purpose processor is usually equipped with logical computation functionality, the net-list can be directly mapped into the machine code to perform logic simulation. One limitation in the compiled approach is that all the gates in the circuit are evaluated regardless of whether or not any change to the inputs of a specific gate occur. In addition, the compiled approach must use multiple instructions for many logic elements. A general purpose CPU is designed to work on only 32 or 64 bit data and the accompanying memory is likewise typically designed to be 32 or 64 bits wide. Hence, read/write operations on larger data strings necessitate multiple clock cycles.

Instead of evaluating all of the gates all of the time as in the compiled approach, event-driven simulation considers a change in one or more input signals as an event. Gates are only evaluated when there is a change in the input signal, that is, when an event occurs.

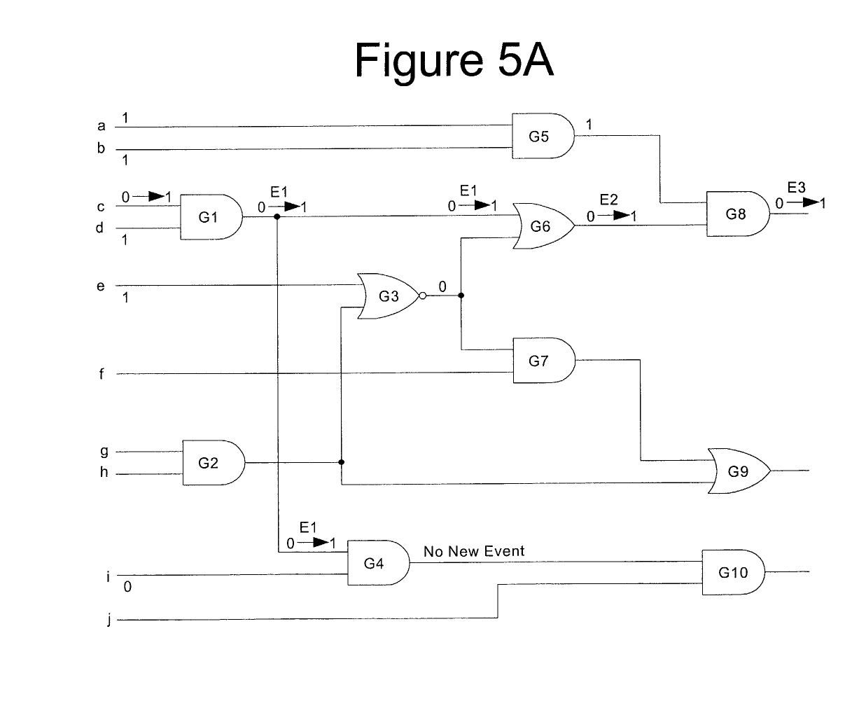

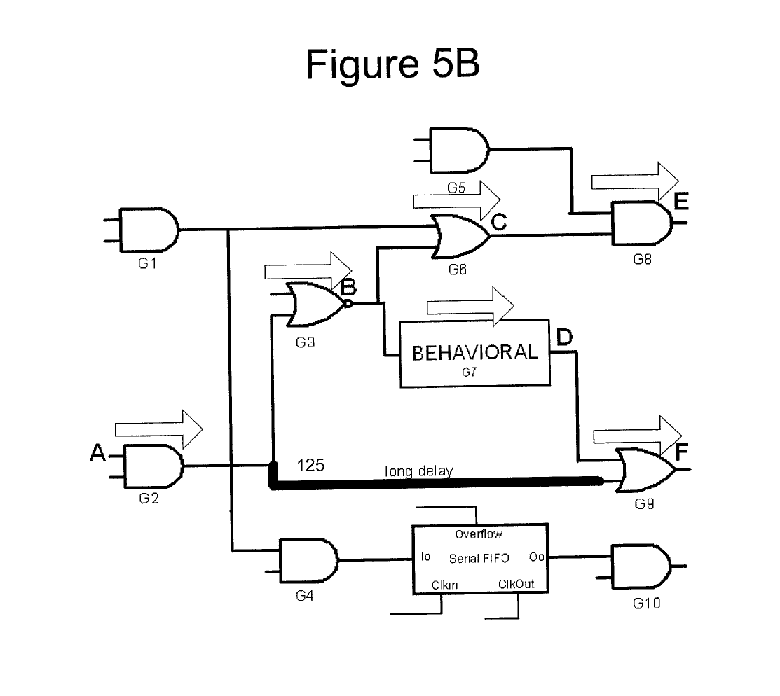

FIG. 5A illustrates the way in which the algorithms work. Although the FIG. 5A elements appear as logic gates, this same mapping could occur for any discrete events to be simulated. Consider a change in the input signal c from ‘0’ to ‘1.’ This event triggers the evaluation of gate G1, which generates an output change from ‘0’ to ‘1.’ The output change of G1 becomes a new event E1, which triggers the evaluation of gates G4 and G6. The evaluation of G6 generates an output change that will generate another new event E2. Event E2 triggers the evaluation of gate G8 that in turn generates the output change and a new event E3. Notice that the new event in G4 is evaluated but it does not generate any new event. Because the input i is ‘0,’ it forces the G4 gate to hold the output value unchanged.

A change in the output signal of a gate at time “t” will generate future events that will occur at some time in the future, t+δt, where δt is some function of the circuit's description or design. More specifically, δt can be defined as:

δt=(intrinsic delay+extrinsic delay+wire delay).

The intrinsic delay is the delay that is based on the type of gate being implemented. For example, an inverter has a smaller intrinsic delay than an exclusive-or gate because it can be implemented using fewer transistors. The extrinsic delay is the delay that is due to the capacitive load that must be overcome to change the logic level. A gate with a high fan-out (large number of other gates attached to the output of the gate) will typically have a higher extrinsic delay than a gate with a smaller fan-out. Finally, the wire delay is due to the capacitive load placed on the circuit due to the output wire length. Generally, longer wires have longer wire delays. The simulation of these (often small) delays is a feature of many embodiments of the present invention.

The generated future events are typically stored in a separate data structure to keep track of the various time delays and the corresponding events so that the simulation engines can safely access the events without executing the events out of order (non-sequentially). When a gate has been evaluated, and it is determined that the output of the gate has changed state, then all the additional gates that are driven by this output signal are evaluated at the future time instant as defined by t+δt above. Logic gates usually have more than one fan-out, and there may be multiple future events being generated as a result of evaluating such gates. These future events have to be managed/scheduled according to their timing information so that all the events can be evaluated sequentially. δt can be different for each destination of the future event. Thus, multiple future events could be generated by an output change.

FIG. 5B shows an additional example of a series of gates, this time also including a behavioral model of a localized part of the digital circuit. A behavior-modeled circuit element G7 is a software representation or description of a part of the circuit provided without actually designing specific gate structures to fulfill the circuit. The description preferably describes how a change on one or more inputs effects a change on one or more outputs. This description generally includes both a description of the state change as well as the timing involved in the state change.

The behavioral model is useful to simulate both sections of the circuit that have already been designed and tested (known parts of the circuit) as well as unknown (or yet undesigned) circuit elements that do not need to be designed at the gate level until some time in the future. The behavioral model is also used in circuit analysis to define parts of a circuit that are purchased as intellectual property (IP) blocks from vendors that do not reveal the exact technological solution. Behavioral circuit modeling is typically only as good as the information provided about the behavioral circuit. The present invention's use of multiple different simulation engines preferably allows for the simulation of behaviorally-modeled discrete events at the same time as other sections of the circuit are modeled in different fashions.

The FIG. 5 circuits illustrates several conventional timing pitfalls that may be addressed by the current invention's ability to accurately reflect wire delays. For example, a data signal will typically pass through short wires faster than it is able to pass through a gate, flip-flop or other circuit element, so a change in an input may “arrive” at a future gate at different times. In FIG. 5B, an event caused by the change in the state of the “AND” gate G2 will be propagated directly to one input of “OR” gate G9 through wire 125 but will be propagated indirectly to the other input of G9 through gates G3 and behavioral-modeled sub-circuit G7. Therefore, output F of G9 may change initially based on the wire input changing but may soon thereafter change again (to a steady state) once the second input from the behavioral-modeled circuit G7 arrives at G9. The simulator preferably takes these propagation delays into account.

In simulating digital logic circuits, four logic levels are typically used: high (1), low (0), high impedance (Z), and undefined (X). Any change from one state to another is considered a discrete event. However, in the more generalized application of the present invention to the simulation of any combination of discrete events, any number of logic levels of any type may be used. As long as the simulation engines are adapted to receive and evaluate the particular pending discrete event, the overall architecture is applicable.

When the size of the circuit, and hence the size of the logic net-list, grows, a software simulation algorithm running on a generic workstation will reach its performance bottleneck. This bottleneck stems from the random memory access behavior of the logic simulation and the future event queue management.

As briefly described above, traditional methods used to address these concerns include using either (or both) parallel processors or hardware accelerators. In a parallel computing environment, each processor (called a processing element or “PE”) is capable of simulating part of the system, and each of the multiple processors must work together to simulate the system as a whole. For example, assume a first processing element, PE1 generates a future event with the time stamp t₁ (one time increment in the future) and this event is to be sent to a second processing element, PE2, because the gate that this event is connected to is stored in PE2. If PE2 is currently simulating an event with time stamp t₅ (five time increments in the future), then this is a violation of the “causality constraint.” Because an event is to be evaluated by PE2 at a time (t₁) which is before the current time (t₅) of PE2, it is possible that all of the calculations in PE2 for the period between time t₁ and the current simulation time t₅ become void. Therefore, PE2's simulation time must be rolled back to time t₁ to consider the event propagated from PE1, actions performed must be unrolled so each gate's inputs, state and outputs are as they were prior to t₁, and the circuit must be re-simulated. Using this asynchronous approach causes a significant amount of work to be “undone” on a regular basis. Additionally, the time for PE1 to coordinate the simulation time is limited by the physical network between PE1 and PE2. Thus, traditional parallel processing has a performance limitation when incrementing simulation time.

Since each of the PEs in a parallel processing system has no way of inherently knowing when the new events will be propagated from other PEs, each PE cannot perform its simulation tasks independently from other PEs. To address this problem, simulation time can be controlled globally to synchronize all of the PEs. This global synchronization can either be continuous or asynchronous. In the synchronous approach, the global simulation time is advanced only when all the PEs agree on such advancement. Hence, the system runs only as fast as the slowest PE for each time period.

In the asynchronous approach, each PE communicates with all other PEs, but is capable of processing events independently of the other PEs. Obviously, since the local simulation time within each PE may be different, there are potential violations of the causality constraint. Specifically, when an incoming event is in the distance future (from the current local simulation time), the PE must decide whether or not it is safe to evaluate the event and create future events. The algorithms used to deal with these parallel processing “causality” situations are classified as either conservative or optimistic.

In the conservative approach, each PE will strictly avoid the possibility of violating the causality constraint. If a PE contains an unprocessed event E with time stamp T and no other events with a smaller time stamp, and that processor can determine that it is impossible for it to receive another event with time stamp smaller than T, then the PE can safely process E because it can guarantee that doing so will not later cause a violation of the local causality constraint. This determination process requires a large amount of inter-processor communication for querying each other's states. This communication includes a high overhead in processor and simulation time.

The optimistic approach, on the other hand, allows the causality errors to occur, and then it detects and recovers from these errors by using a rollback mechanism. The recovery process is typically accomplished by undoing the effects of all events that have been processed prematurely by the processor. An event might have done two other things that have to be rolled back—the event may have changed the output of a logic gate, or it may have sent an event to another processor. When no errors occur, the optimistic approach has better CPU utilization than the conservative approach, but when many rollbacks are needed, this utilization drops rapidly as processor cycles are wasted.

As briefly mentioned above, some attempts have been made to use hardware accelerators to speed up the traditional software implementation of a simulator. These hardware accelerators can generally be classified as hardware simulators and emulators. A hardware simulator runs the simulation algorithm on dedicated hardware, which can help provide fast and accurate results. Hardware logic emulators, on the other hand, utilize PLDs such as FPGAs as a platform on which to program the entire net-list. Therefore, in simulation, the circuit functionality is simulated, and in emulation the circuit functionality is physically laid out and run.

In general, emulators are faster than simulators since the logic elements inside the PLD literally execute the logic function given by the input net-list (rather than using table look-ups in memory to simulate the evaluation). However, hardware emulators can only emulate, not simulate, and they lack the functionality of correctly simulating the circuit's characteristics given by the designer's intention and/or the target technology. In other words, the hardware emulators may only be used to perform the circuit's functional verification (i.e., logical correctness). The actual behavior and timing of the target technology cannot be emulated.

It has been shown experimentally that typically prior art simulation engines spend less than approximately 10% of processor time actually evaluating events. The vast majority of time, between 65 and 85%, is spent scheduling future events. This wasted time occurs because the general purpose computer is not designed specifically for logic simulation. As shown in FIG. 1, the present invention addresses this scheduling problem by, among other things, separating the scheduler which sorts the pending events from the simulation engines that actually evaluate the circuit elements based on those events.

Among other problems, multiple read/write cycles are needed to read a data object from memory, update its results, and put the changed data object back in memory. These data objects include not only information about the type of gate involved, but also input and output values and pointers to fanin/fan-out gates. The typical general purpose computer memory bus is not wide enough to easily handle this wide information, and multiple read/write cycles are needed.

Also, unlike many conventional computer programs, a logic simulator program accesses memory at “random,” non-sequential locations (depending on the connectivity of the circuit). Therefore, the cache memory will exhibit more cache misses than cache hits, thereby wasting additional processor time. Also, a general purpose computer uses processor time for functions that are not used by the logic simulation, such as operating system overhead, multitasking, graphical user interfacing, and virtual memory. The present invention addresses one or more of these hardware design problems inherent to utilizing a general purpose computer for logic simulation.

Now that the basic functionality and limitations of conventional discrete event simulators, and more specifically logic simulation, have been presented, a general description of the methodology and components used in at least one preferred embodiment of the present invention will be described. The system will be presented generally at first, and a more detailed description of each system component will be provided thereafter.

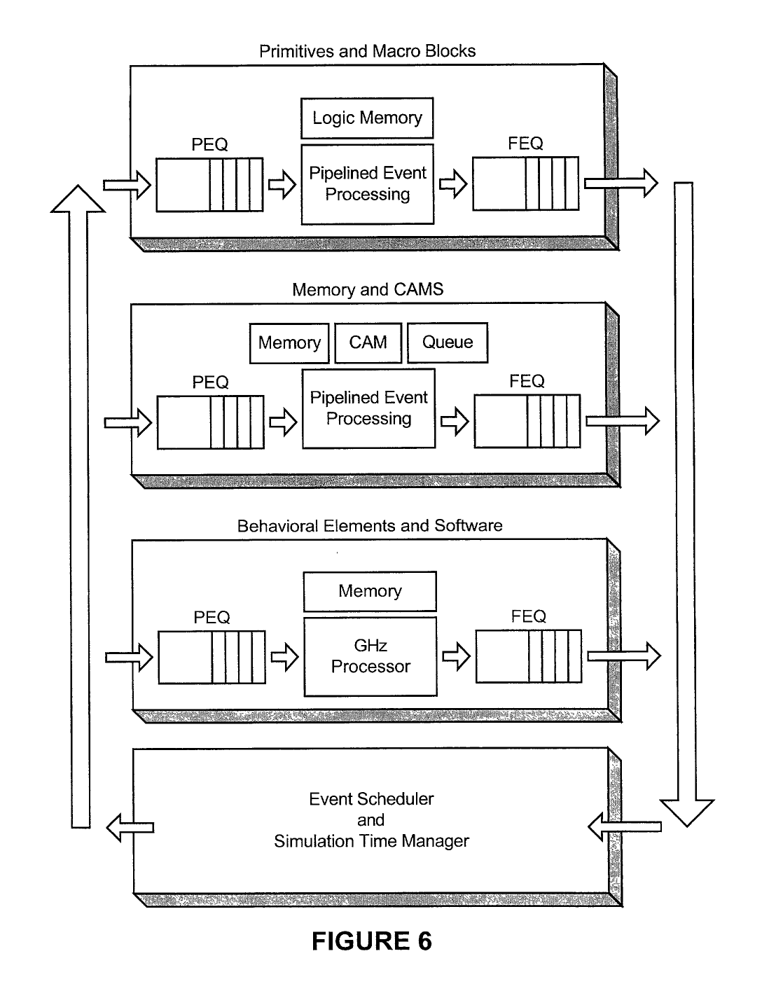

FIG. 6 shows a general block diagram of one presently preferred embodiment of a discrete event logic simulation engine. The system preferably includes an event scheduler and simulation time management block and one or more simulation engines that evaluate parts of the circuit. In the FIG. 6 example, there are shown three simulation engines: (1) the primitive and macro block (logic) engine; (2) the memory and CAMs (content addressable memory) engine; and (3) the behavioral elements and software engine. It should be noted here that there may be more or less than three engines depending on the circuit to be simulated and the desired technology to be used, and multiple engines of the same type (e.g., two different primitives and macro block engines) may be used in various embodiments of the present invention.

The scheduler and each specific simulation engine are preferably communicatively connected to each other by one or more event queues which may be conventional first in/first out (FIFO) pipelines. These event queues guide the events to be evaluated at a later time from the scheduler to a simulation engine and guide the future events (events to be evaluated) from the simulation engines back to the event scheduler to be sorted. In

FIG. 6, there is shown a pending event queue and a future event queue for each simulation engine. Although these pipelines are depicted with one arrow in FIG. 6, in practice they may include several pipelines which directly connect each simulation engine to the scheduler.

There may preferably be at least four different types of simulation engines for use with the present invention. The first simulation engine is preferably a logic (primitives and macro) simulation engine. The logic simulation engine evaluates the various gate logic that exists in the integrated circuit to be simulated. For example, the logic simulation engine includes the “AND's,” “OR's,” flip/flops, and other basic logic components used in larger integrated circuits. The logic simulation engine of the present invention preferably includes a full custom architecture to optimize the logic simulation process. It may include multiple memories and a way to map each circuit location to a specific point in memory. More on this will be provided below.

The second simulation engine may be a memory simulation engine. The memory simulation engine includes standard memory, content addressable memory and other data storage devices. Standard memory is a type of data storage in which a specific point in the memory is addressed and a read/write signal is applied to the memory to determine whether data is inserted into the memory address from a bus or data is read for the memory onto the bus. Content addressable memory includes the functionality to present a piece of data to the memory and query the data whether this data exists somewhere in the memory. If the data does exist in the memory, the return value is the address of where the data exists in the content addressable memory. Content addressable memory basically functions in the reverse of conventional memory.

Content addressable memory is used heavily in networking applications. It is useful for table look-up applications. Basically, the destination of a packet of data is presented to the memory and the memory is queried for the data's location. The memory returns an address that can be used to locate additional information about the data.

This simulation engine preferably determines how to simulate memory. This engine may include a mixture of both functional emulation and timing simulation processes. The emulation components physically mimic the memory accesses as defined by the circuit that is being simulated. However, emulation does not include gate delays and is therefore technology independent. Simulation elements can then be added to the emulation to generate future events with an accurate time stamp including technology-specific delays. A single RAM/CAM can be used to emulate multiple RAMs/CAMs by providing an offset for a RAM and an additional identification field that must always be matched for a CAM.

A third simulation engine may be a behavioral or software simulation engine. The behavioral simulation engine simulates, through software, the behavior of both large and small circuits. With behavioral modeling of circuits, exact gate structure and design is not necessary. Instead, the behavioral simulation engine merely determines various inputs and outputs at a high level without analyzing the specific gate structure of each element. A behavioral circuit model is useful to simulate very large designs or to simulate designs that have not yet been reduced to an actual layout of gates and other components. Also, the simulation of some gate-level areas of the circuit may take too long to perform, and the higher level behavioral model is preferred for efficiency considerations. This allows entire integrated circuit designs to be simulated even when specific parts of the design have not been completely designed.

In essence, this block allows part of the simulated circuit to be represented by software. This simulation engine preferably includes a memory and a microprocessor to store and retrieve data from the memory. Logic within this simulation engine will be defined behaviorally through software.

The fourth simulation engine is an interconnection and net-list/annotation simulation engine which embodies algorithms to facilitate faster processing (singly or in parallel) of model topologies, interconnection timing or other influences (e.g., impairments such as crosstalk, contention, etc.) and facilitates rapid processing of physical annotation and lookup of individual model connections (“nets”) and interconnection properties.

The combination of the above four or more simulation engines (i.e., logic, memory, behavioral, and interconnection) have not heretofore been incorporated into one discrete event simulator. However, the present invention is much broader than these four concrete examples. In actual practice, any simulation engine capable of evaluating a type of discrete event (including non-logic events) may be used with the system and methods described herein. The digital logic examples offered are for explanatory purposes only.

The separate event scheduler and directly connected simulation engines are designed to alleviate the observed problems with the prior art simulation systems. For example, in a logic circuit with 10 million or more gates, you may be sending a million packets around the system at any one point in time. Each piece of information must be packetized with address header information, sent out, and then unpacketized at the destination that it can be used. All of this data packaging is wasteful from a simulation point of view. In a parallel processing simulating, this overhead is on the order of 40-60%.

In some embodiments of the present invention, packetizing of the data is necessary because all of the data in the dedicated queues is to be evaluated by the selected engine. These point-to-point wires send electronic signals in a single direction for a more simplified communication scheme in relation to the prior art.

The separation of the scheduler from the simulation engines (evaluators) has at least two advantages. First, communication is made easier and more efficient because all events sent to a simulation engine via a pending event queue are evaluated (no decision-making at the simulation engine). Second, no piece of logic will be evaluated unless it needs to be. There is preferably no evaluation, detection of a mistake and then a roll-back in time to re-evaluate part or all of the circuit. This is a conservative approach to logic simulation. The optimistic, prior art, approach is to assume no event occurs in the past, evaluate the gate, and then roll-back time if necessary. Obviously, this process is wasteful.

After receiving a pending event in its pending event queue, the simulation engine evaluates the event and generates future events, if any, that are created based on the evaluation of the pending event. These future events are combined with a time δt which represents the gate, wire and/or capacitive load-based delay associated with the future event and are sent to a future event queue and then sent to the scheduler to be scheduled.

Turning to the process by which the present invention simulates discrete events, the run-time simulation is enabled based on an initial “pre-processing” step in which the circuit is set up to be simulated within the discrete event logic simulator. This pre-processing step is generally a software algorithm that partitions the circuit to be simulated into the four (or more or less) functionally different types of logic representations (gate logic, memory, behavioral, and interconnections). Once partitioned, the net-list of the circuit is directly mapped into the memory of the various simulation engines. During runtime, when a particular gate or circuit segment is to be evaluated, the message (event) is sent to the simulation engine that has that gate stored in its memory. The message (a pending event) preferably identifies the gate (or RAM, etc.) to be evaluated and provides the event criteria, such as a change in a gate input.

The future event queue collects all of the generated future events and transmits them to the scheduler. The scheduler will then sort these future events to be evaluated and transmit these future events (now as pending events) to the pending event queues once the time for evaluation occurs.

The pending and future event queues are preferably like a buffer that temporarily holds the events until evaluation or scheduling. The queues act as a direct pipeline or conduit between each simulation engine and the scheduler. These pipelines are preferably continuously in operation. Specifically, the future event queue will continually send future events to the scheduler to be scheduled, and the pending event queue will continually transmit pending events to the simulation engines to be evaluated. The scheduler does not need to wait for a certain number of events to be evaluated, it continually scans the future events and organizes the events in the proper chronological order.

To prevent the scheduler from sending an event into the pending event queue before an incoming “future” event upon which the pending event depends is received by the scheduler, the scheduler takes the gate (or other model) delay times into account. For example, the scheduler may calculate that each gate has a minimum 20 picosecond delay. Therefore, the scheduler can send events to the various pending event queues that occur before this 20 picosecond time period expires. Specifically, if events are scheduled at 5 picosecond intervals, the scheduler can send events that are 0, 5, 10, and maybe even 15 picoseconds in the future, and know that the timing for the evaluation of these gates will not be violated. Therefore, the scheduler can continue to fill the pending event queues with events separated by short time frames, and the scheduler does not, therefore, have to wait until all pending events are evaluated and all future events are generated before sending the next group of pending events. Because of the relatively larger gate delay (compared to the scheduler's minimum time interval between events), timing principles are not violated. As long as there are a sufficient number of events being generated, there will be a constant “trickle” of events being sent throughout the simulation system.

Exemplary Component Descriptions

In the logic simulation primitive case, one method used to optimize and compact primitives is accomplished through the structural implementation of a “universal device primitive.” Since many primitives have many inputs, and thus enormous memory would be required to hold millions of instances of each, the invention subscribes a reduction algorithm to each, observing that for “NAND,” “AND,” “OR,” “NOT,” and “NOR” gates, there are generally two sets of input truth table entries that define the gate. In the NAND gate case, if any input is “0” the output is always “1”; if two, three, . . . N inputs are “0” in any combination, the output is still “1.” This suggests that these gates behave according to an “ANY” function. Then, if ALL inputs are “1”, the output of the NAND is “0.” This suggests for all these gates an “ALL” function. The ANY and ALL functions, and a third class for handling “X” reduces significantly the memory required to hold an instance of a gate. As the number of inputs increases, the memory needed to hold large truth tables in prior art simulators is a direct impairment on their effectiveness, reducing the number of gates they can contain.

Continuing the optimization of primitives into “AND-OR-INVERT” (AOI) and the many variations of OR-AND-INVERT (OAI), etc., and continuing the ANY, ALL, and X functions into Flip-Flops (FF) and Multiplexers (MUX), the present invention can model nearly all commercial or ASIC primitives found in an IC Library from IC Manufacturers using these compact primitives (universal device primitives). The NAND, AND, OR, NOR, AOI, OAI, FF, MUX primitives in the invention are the traditional building blocks of 90% of commercial manufacturers' libraries. The present invention's libraries thus may require a parse and translation to instantiate in the engines.

One exception to the above is that the XOR or exclusive-OR/NOR gate is handled as with other gates, but a small amount of memory is required to fully emulate “races” that can occur as the XOR's inputs could be simultaneously changing. The XOR hasn't an ANY and ALL function, however the invention exploits its ability to handle mixed modeling methods (in this case, truth table and hardware emulation) to complete the coverage of commercial primitives.

Once in the resident library within the invention's set of preprocessing software, individual primitives carry attributes necessary to compute gate delay, thermal dissipation, and other indirect simulation parameters. When a net-list is built, the invention places instances or copies of each primitive (and connections) for as many gates as called for by the circuit.

The PEQ and FEQ

A PEQ and FEQ preferably exist in each simulation engine, as shown in FIG. 6. In simple terms, the pending event queue (PEQ) is filled initially by the scheduler. The evaluating engine evaluates events stacked into it, then places the results in the future event queue (FEQ). Since during the normal course of simulation (as illustrated in FIG. 5B and “re-evaluation” discussion) not all the results of gate (model) events resolve in perfect chronological order, it may be necessary for the scheduler to sort the FEQ from each of the engines to see if any one or more events in the FEQ are not chronologically sequenced. Sorted events become pending events when their execution time is less than the simulation time, and these events are distributed and placed in engines. PEQs, thus can contain “fresh” new events to simulate. The scheduler manages the FEQ and PEQ of each simulation engine.

The pending and future event queues eliminate the need to use a general purpose PCI or other computer bus and plug-in card which has access times on the order of 250 nanoseconds. The scheduler's pipeline can transfer the events from input into the sorted schedule in two clock cycles, currently approximately 5 nanoseconds.

The event scheduler to simulation engine connection is always point to point, but the actual implementation may vary. For example, there may be a direct, single line communication connection between the scheduler and each respective simulation engine. The scheduler then merely needs to decide where the event is supposed to go, and send it there.

Alternatively, a more conventional bus architecture may be utilized between the simulation engines and the scheduler. However, to at least partially alleviate the burden of addressing overhead on each sent packet, the present invention will preferably include an “alternating” or other predictable communications system. For example, the scheduler may send pending events to the simulation engines by alternating between each engine on a regular basis (rather than putting a packet on the bus and relying on the engine to decode the message addressing.) If the time comes for the scheduler to send an event to a simulation engine and the scheduler has a pending event to send, the event is sent. The receiving simulation engine will know the packet is intended for that engine because it is the appropriate “time.” If, on the other hand, the time comes for the scheduler to communicate an event to a certain simulation engine and there is no pending event to be sent, the scheduler will preferably not put any event on the bus and wait for the time to send the next event to the next simulation engine. Although some clock cycles will be “wasted” when there is no event to send to a certain simulation engine, this wasted time is preferably smaller than the amount of time “wasted” in a conventional bus addressing scheme. Also, this “regular alternating” addressing scheme could be tailored toward the specific simulation engine architecture in each simulation (e.g., if one particular engine evaluates twice as many events as the other simulation engines, the scheduler should be set up to send events to that engine twice as often as to the other engines.)

Event Structure

As mentioned above, the basic premise of the simulation engine is to convert a discrete system into a “net-list” of interconnected discrete system components. For example, in a digital logic system this would be the interconnected gates and other discrete events in time. A full description of each gate includes a gateID (generally, model-ID), gate type, input designations and values, output designations and values, connection (fan-out) information, and other information as needed and just described. However, as future events are created, sent to the future event queues, sorted by the scheduler, and sent to the pending event queues, these events do not need to include all of the information to describe the gate.

For example, consider the case of a simple gate input change as would take place in the primitives and macro simulation engine (the “logic engine”) while simulating an IC. The full description of that gate (including its current input and output values) preferably resides in a memory within the logic simulation engine. Therefore, to send a pending event that will re-evaluate this gate based on an input change, the event sent and sorted through the system, preferably needs to include a gateID (to determine which gate is being evaluated) and some representation of the input change. This may just be the input pin number and new value, or it could include almost any variation on this theme.

This pattern may repeat itself across all of the various simulation engines and all of the various model types. Preferably, only that information that is needed to identify and communicate the model and the change to the proper simulation engine are sent. Because the full event data structures reside in the engines themselves (in memory), and further because all events received in a simulation engine's pending event queue will be evaluated (the scheduler makes this decision), the data transfer structure (gateID+event) can be simulated. In a simple logic simulator, this may be gateID and input change. In a memory simulation engine, it may be a RAM ID and a new data value to be written to the memory. In a software engine, it may be a program sequence identifier and a register transfer. Regardless of the simulation engine written to, and regardless of the field of use, the system preferably uses this model-ID, event structure to transfer events throughout the system.

The algorithm for displaying simulation results can monitor the activity in FEQ as it moves into the scheduler so that the scheduler can extract states, event occurrence, activity by model-IDs, etc., for presentation as results. Because of the generalized and complete nature of the pending and future events, this process is streamlined in relation to the prior art.

Pipelined Simulator Engines

The pending and future event queues are pipelined to maximize the data transfer rate of events throughout the system. In much the same way, some or all of the simulation engines themselves may also be pipelined to allow for the maximum transfer of data even during actual evaluation.

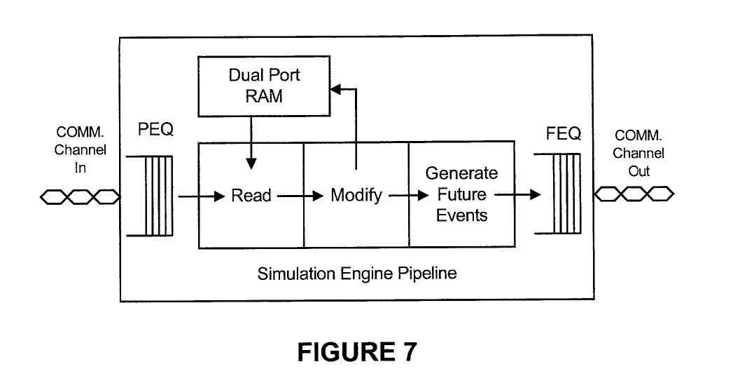

For example, FIG. 7 details a general structure for a simulation engine such as a logic simulator. The FIG. 7 engine includes an incoming pending event queue PEQ and outgoing future event queue FEQ, shown here as a communications channel. To evaluate the incoming event, the engine generally needs to read the full event structure from data (based on the received gateID), modify that structure (based on the received event, such as an input change on a certain input pin) and write it back to memory, and generate future events based on that modification. Because these functions all typically take more than one clock cycle to perform, pipelining the internal data processing within the simulation engine is preferred.

Assume an average read and write process takes only two clock cycles (because the memory used is wide enough to read and write the entire gate description at one time.) Assume further that a typical modification process takes 5 clock cycles because some calculation, data look-up, or other functionality is needed. Without pipelining, each event in the pending event queue would take 2 (read operation)+7 (modify and write operations) clock cycles just to get to the point where future events are created. To completely process a pending event, 10 or more clock cycles would be needed. Without pipelining internally, additional pending events would simply wait in the pending event queue until the first event is completely processed. This problem becomes even more pronounced when a complex modification process in a simulation engine, for example a 20 cycle memory access, is used.

In at least one embodiment of the present invention, the internal processing functions are pipelined as much as possible. For example, if the FIG. 7 modify operation block was expanded into 5 (or 20, etc.) functional blocks that each took one clock cycle to perform, the process would be streamlined. Upon the triggering of each clock cycle, a function is performed and the data is latched to the next block. Therefore, in the first clock cycle, the full data description of a first gate would be read from memory. In the next (or a successive) clock cycle, this data description would move to the first modify operation block to begin the modification process. During this same clock cycle, a second gate description (identified by the next pending event) could be read from the memory as part of the read operation. On the next clock cycle, both of the pending events would be latched to the next modification operation blocks, and a third pending event would be read from memory.

In this example, the first pending event would still take the same amount of time to be fully processed because each pending event must still go through the entire read/modify/generate future events process. However, the simulation engine would finish processing the second pending event during the next clock cycle because it is only one operation block behind. Therefore, after the initial overhead of filling the internal operational pipeline, events could be processed in as fast as one clock cycle.

This pipelining becomes more efficient when dual ported memory is used. Because most read operations from data will be followed after a data modification step by a corresponding write of updated values back to memory, it is beneficial to use a memory structure that allows simultaneous read and write operations. This is the essence of the dual ported memory. With single ported memory, some type of pipelining could still be used, but it may not be as efficient as that just described. For example, the pipeline could be created so that every clock cycle would include a read or a write operation with no clock cycles “wasted” only performing a modify. Alternatively, some type of shadowed memory could be used.

This internal pipelining may be used with a variety of simulation engines. The above example is similar to a logic simulation engine. A memory simulation engine with internal pipelining may be more complex and will be described in more detail below. Some other engines, however, may not be amenable to this pipelining process, at least in full. For example, the behavioral or software engine may be too event specific during some user-software execution routines.

Again, additional algorithms for displaying simulation results can monitor the activity of PEQs and FEQs across parallel pipelines into and out of the scheduler and/or each simulation engine so that the scheduler can extract states, event occurrence, activity by model-IDs, etc., for presentation as results.

Simulator Engine For Logic Primitives

The primitives and macro blocks simulation engine preferably includes a logic memory and a pipelined event processing module. The logic memory is a memory bank that includes descriptive information about each gate, primitive, macro or other information about the logic elements that make up the circuit to be simulated. Preferably, the memory is wide enough so that the entire description of each gate can be read to and/or written from the memory in one parallel block. For example, the logic memory may be 144 bits wide.

The pipelined event processing queue holds the events from the pending event module that are currently being evaluated. Generally speaking, the pipelined event processing module preferably includes the address information for a specific gate that is the subject of the incoming pending event. This incoming event will preferably include a change in an input value or other variable that is part of the gate memory structure. The pipelined event processing queue reads the memory information about the gate to be evaluated, changes the input or other variable, evaluates the gate, and then stores the updated gate information back into the logic memory. This process also creates new future events (if applicable) that are then time-stamped and sent to the future event queue to be sent to the scheduler. The next incoming event from the pending event queue may then be evaluated by the same process in the pipelined event processing.

Each logic element (gate, RAM, etc.) in memory preferably includes a gateID, gate type (e.g., AND/OR/XOR), input identifications and initial values, output identifications and current outputs, and a list of destinations (interconnections). Each of these elements of the logic gate description is meant to describe the current state of the gate. When new events affecting this gate are received (e.g., a change in a gate input state), the pipelined event processing module reads the logic gate memory description, updates the description based on the incoming event, evaluates the outputs of the gate, generates new future events (if any) based on this evaluation, and stores the new logic gate memory description back in the logic memory.

One way in which access to this memory logic description may be streamlined is to make the gateID the actual address (or part of the actual address) in memory in which the gate logic description is stored. In this way, the pending (incoming event) will have the correct memory address already embedded in the event (as opposed to having to look up an address from an addressing table) which will make the accessing of that logic gate description faster than conventional addressing methods.

The gate type is preferably a five to ten bit representation that references a predefined table in memory (if tables are used with this engine). This predefined table basically includes a truth table (evaluation table) for the specifically referenced gate. For example, a type “1” gate could be a 2-input-AND gate, and a type “2” gate could be a 4-input-OR gate. In one preferred embodiment, when the pipelined event processing module attempts to evaluate a gate, the module looks up the correct truth table outputs based on the input states found in the logic memory and the truth table stored in memory. Therefore, these truth table modules can be reused by all logic gate memory descriptions that contain the same gate type. Alternatively, the universal device primitive, described above, could be used to compute the outputs of AND/OR/NOR and other gates, rather than using a table lookup.

Most logic gates will have only one output, but the logic gate memory descriptions may be capable of having more than one output. Also, the logic gate may be connected to more than one destination gate and the logic gate memory description is preferably able to create future events based on different types of destinations. As stated above, once these future events are created, they are preferably sent to the future event queue and are then forwarded to the scheduler to be sorted. Preferably, these destinations are also identified by their actual memory address, so these future events will also have a direct link to the logic gate memory description. In this way, the future events will be associated with the address in the logic memory which holds information about that logic gate, primitive or macro.

In addition to modeling each gate and sending the future events to the scheduler, the logic engine could also be designed to perform the simulation of a group of gates. This design is different than described above but could be used in conjuncture within the same platform. Rather than using a separate scheduler, the logic gates would be emulated with the above mentioned “Universal Gate” on Universal Device Primitive concept, and its output would be directly wired to the input of other gates being emulated.

The standard emulation approach is to increase the clock rate as fast as possible as long as signals have enough time to propagate through the logic until the next latch or storage device; in essence, the clock period should be the exact time required for all signals to become stable.

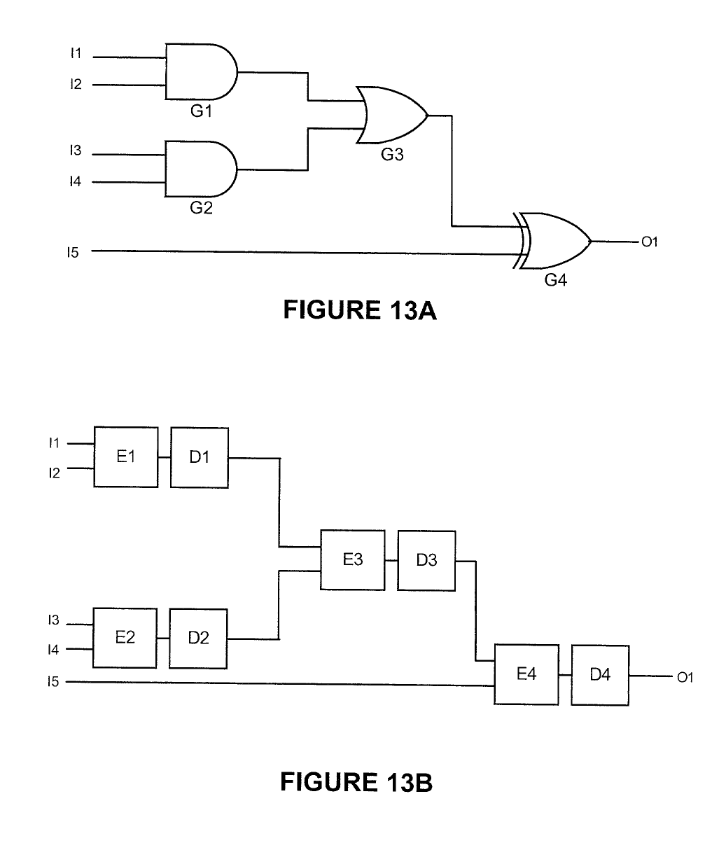

Rather than maximizing the clock rate to increase performance, the present embodiment utilizes that clock rate to simulate the actual timing of the circuit to as precise a level as the user requires for that particular simulation run. Each circuit module, a gate or circuit subsection which can be arbitrarily large or small, is replaced by two components: the emulation component and the delay component. The emulation component, shown as E1 through E5 in FIG. 13B, replicates the functionality of the circuit module as fast as possible. The delay component delays the output of the E component by a predetermined number of clock cycles. The quantity of delay is to be proportional to the delay through the module as defined by the target technology of the module when it is fabricated. This information can be calculated by a number of means and is determined prior to simulation.

FIG. 13A shows an example circuit with the gates labeled at G1 through G5. All inputs are labeled I1 through I5 and the output is labeled O1. Note that this figure represents actual gates but the actual usage may have a group of gates. For proper simulation results, the delay through G1, G2, G3 will be longer than the delay from the input I5 if the signals all come from a commonly clocked latch or storage device. However, if the signal I5 arrives much later than the inputs I1 through I4, then the results will change according to the delay. Similarly, the output O1 will change according to the arrival of signals I1 through I5, the delay through G1 through G4 and other similar delays. Emulation does not represent the true timing-dependent nature of this type of circuit because it does not have the ability to represent, delay through each of its components nor could it properly emulate the circuits behavior unless a storage device was added to synchronize the input signals. This limits the knowledge that the designer has about the circuit after a fabrication technology has been selected.

As stated above, the circuit to be simulated is transformed into another circuit that has two components for each module of the original circuit. Each gate or module, G, is functionally emulated by a circuit E, and its timing is simulated by a delay element D. Circuit E emulates the functional behavior of G in a constant number of cycles. The delay element D further delays the output by a configurable number of cycles. In this way, the element G is delayed T time cycles. Once a target technology has been selected for G, the delay through G in seconds will be known. Typically this is in picoseconds (ps). Suppose that this delay is P. The D circuit will delay the signal T time cycles such that the quantity T plus the fixed delay through E plus any fixed routing delay to propagate the signal to the next E element. In this way, the delay through G is proportional to the actual delay after a technology has been selected. For example, if P is 100 ps, E is 2 cycles, routing is 10 cycles, then D would be 100−2−10=80 cycles. Thus, by creating this second-to-cycle ratio, the exact timing of the circuit can be determined and its behavior can be emulated with full timing information. In such a circuit a clock signal would be proportional to the second-to-cycle delay of the circuit and the proper signals would be latched at the proper time. Thus, if the second-to-cycle ratio is 1 ps to 1 clock, a 1 nanosecond period clock would occur every 1,000 cycles. The clock-to-cycle ratio can be altered to meet the accuracy requirement of the circuit.

In addition to timing accuracy, this approach is superior to traditional emulation because the routing of the delays between the modules G can be a fixed quantity that can be fairly large. In traditional emulation, a place-and-route step is required so that the routing delay is minimized to increase emulation performance. In the approach of this embodiment, the routing delay can be used to properly simulate the timing of the circuit. For example, suppose that the routing between two modules, from G1 to G2, R cycles. The D1 value from G1, would take into account R and only delay the signal the proper number of cycles. To be specific, D=T−E−R.

It should also be noted that this architecture can be used for general simulation in which very accurate timing is needed. The modules G could represent a section of a factory line that transforms an input into an output after a specified amount of time and taking into account problem, product defects, equipment repairs/down time, etc. Thus, the only application requirement for this approach is high-fidelity timing and a discrete event chain of events.

Memory Engine (with pipelining)

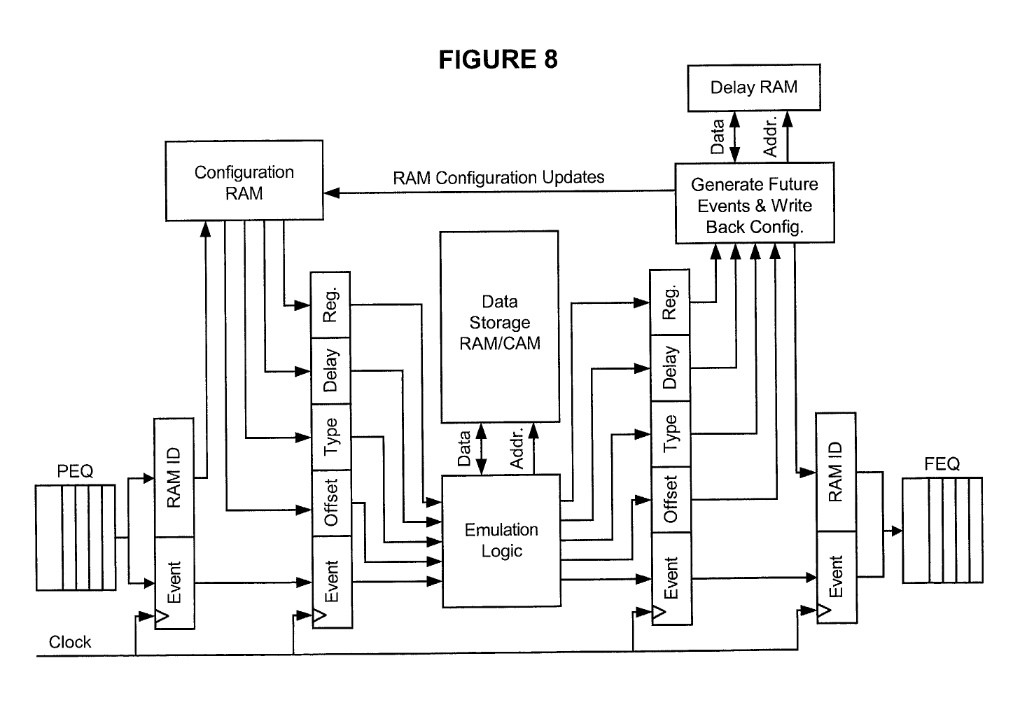

FIG. 8 shows one embodiment of a memory simulation engine for use with the present invention. As briefly described above, the memory simulation engine simulates the functionality of a wide variety of user-defined memory access events. Because the data must be stored for future operations, a memory simulation engine will typically include both emulation and simulation components. The data itself will be emulated to assure logical correctness and data accuracy, and the timing associated with memory access operations will be simulated and added to the future events to assure a technology dependent simulation is provided.

FIG. 8. shows the incoming pending event queue PEQ with the pending events including a RAM ID and an event. This data is all that is needed to be presented to the memory engine because it can identify both the RAM to be manipulated and the type of manipulation that occurs. The memory engine (and other engines) preferably include a Configuration RAM that holds all of the configuration information about all of the various RAMs being simulated. The RAM ID from the pending event is passed to the

Configuration RAM, and the Configuration RAM passes back details about the identified section of RAM. For example information about offset, type, delay, registers, or any other information may be provided. This information may change depending on the currently intended memory access, but the same basic structure may be used for all memory accesses.

This configuration information is combined with the event information, which described the “change” in input or other conditions that necessitates the re-evaluation of the identified memory, and all of this information is then preferably passed to an emulator (Emulation Logic). The emulator is a platform independent storage device that actually holds the information of the simulated RAM/CAM. The emulator is used to walk the simulator through the various memory accesses to ensure that the system functions as designed, but the emulator does not assist in timing characteristics. Because the emulator logic will typically access various different types of memories and various different subsections of each memory type, the emulation logic is preferably connected to a Data Storage RAM that stores the various circuit memory data. For example, the current section of memory (identified by the pending event's RAM ID) may be downloaded from the Data Storage RAM to the emulator for processing. After processing, the modified data will then be stored back in the Data Storage RAM. This Data Storage RAM also preferably includes the instructions for carrying out whatever memory access is desired by the current pending event. In this way, the Data Storage RAM acts as a functional lookup table.

After the emulator processes the current event, the offset, type, delay, register and other information is collected and sent to a block capable of generating future events based on a change in the current event. This block combines the newly modified event with timing and delay data stored in a Delay RAM to produce one or more future events that are time stamped to be evaluated at some point in the future. These future events are queued in the future event queue FEQ to be passed back to the scheduler for sorting.

The future event generator block preferably also has the functionality to pass the updated RAM configuration data back to the Configuration RAM. Because the configuration has changed, and further because the currently pending events get their configuration information from this Configuration RAM, this RAM must be updated when its contents are changed by the emulator. By separating the configuration, emulation, and future event generation in this pipeline configuration, the throughput of processed events increases significantly (multiple operations can occur simultaneously).

Many types of memories could be included in a memory simulation engine. For example, both traditional and content addressable memories may be preferred for different simulated circuits. The variety of available memories, coupled with a vast array of delay characteristics for different fabrication technologies found in the delay RAM allow a great deal of flexibility in this engine.

Net-List and Interconnections Engine

The net-list and interconnections engine (“net” engine) may be used in the same way as the above engines, or it may alternatively be used in conjunction with the functionalities of the other engines. For example, in at least one presently preferred embodiment, the net engine provides a mechanism for providing specialized interconnecting of simulated objects within a discrete event simulation. This engine provides a method of routing single events from the output of a simulated object to multiple inputs of other simulated objects. The nature of this engine is generic and not specific to a given application but may be customized as needed for a given simulation task. Interaction among the events being routed is possible and event times can be altered by knowing the state of each of the simulated interconnections among the simulated objects.

As an example of the net engine, a preferred embodiment of the net engine is described in the context of discrete event logic simulation for digital circuits. The architecture of the net engine is not limited to this particular application.

As shown in FIG. 5, a circuit element's output may be the input to a number of other circuit element's input. This single output to many, typically one to ten, inputs is called fanout. In the physical device a single wire connects the output to many inputs of other gates and affects the delay of the output because it has electrical capacity.

In circuit simulation, the added wire delay can be modeled as a single delay value that is added to all output-to-input paths. This lumped capacitive model is the simplest model because it provides a single delay value to the extrinsic delay. If a distributed capacitive model is used, each output-to-input wire is modeled separately. In this model, each path can have a separate delay value that is added to the extrinsic delay.

The routing of wires within a chip can have an impact on the signal integrity of a particular output-to-input wire. If there are multiple wires running parallel to a “victim’ wire and they all transition from ‘0’ to ‘1’, then the victim wire may transition or have its own transition altered. Similarly, if the multiple wires are all ‘1’, the victim wire will require more time to transition from ‘1’ to ‘0’ than it will from ‘0’ to ‘1’ because of the ‘1’ on the many wires surrounding it. These and other factors can change the behavior of a circuit event and thus must be simulated to achieve the most accurate results for circuit technologies susceptible to this interference. Typically, the smaller the technology device size, the more susceptible the chip will be.

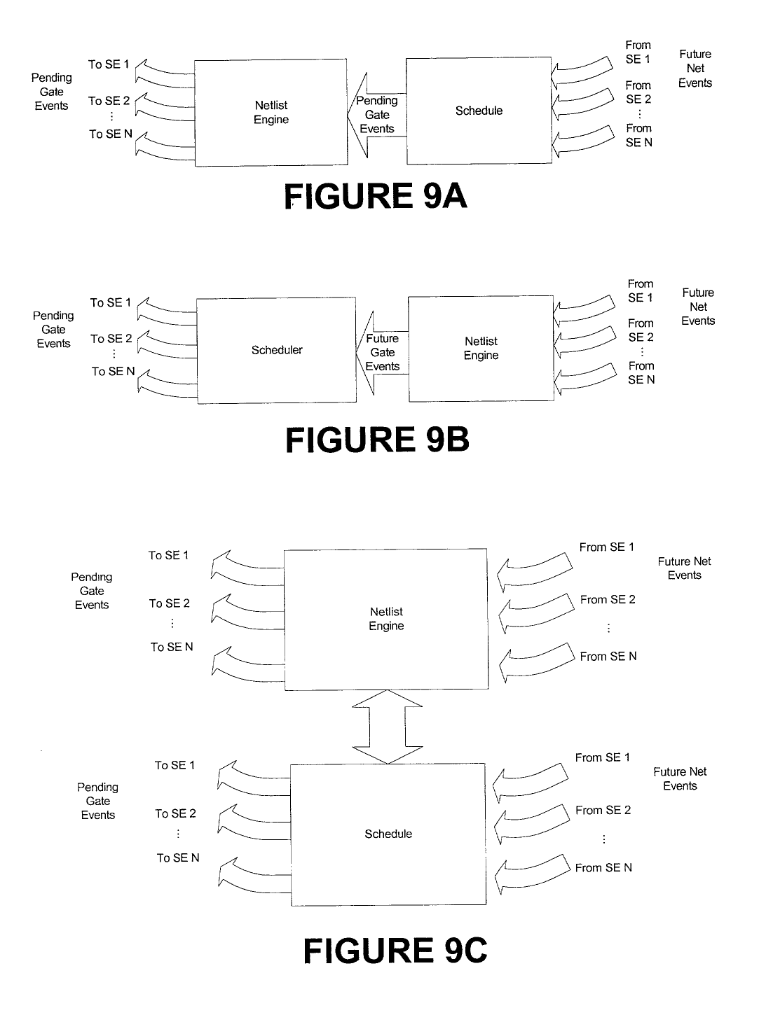

There are many potential embodiments of the net engine. This device, as shown in FIGS. 9A-C, may be placed between the scheduler and each of the simulation engines. In this figure, one of the functions of the net engine is to translate single output events into multiple events. Thus, the net engine models the interconnecting wires between the outputs of each gate and the inputs of other gates. In a lumped capacitive model, the delay for a single fanout net will be a single value, and, through software preprocessing, this value can be added to the gate delay. In this way, a single delay, intrinsic+extrinsic values, can be stored with the gate generating the output. Therefore, the net engine does not have to add the wire delay because it has already been added to the gate that generated the output.

The main job of the net engine is then to provide a method of storing the destinations of each gates output.

In FIG. 9A, the net engine is placed after the scheduler and before each of the simulation engines. In this figure, we label output events as net events because they occur on a particular network of wires that interconnects the output to many inputs. Similarly, we define gate events to be an event that appears at an input of a particular gate after it has traversed the output to input path. The simulation engines in this embodiment generate net events that are to occur at some future time, labeled as future net events. The scheduler then only has to schedule one event rather than the many gate events. Once the net event's execution time occurs the scheduler transforms the future net event into a pending net event and sends it to the net engine. The net engine then translates the pending net event into a number of pending gate events. The gate events are then immediately sent to the appropriate simulation engine.

The net engine preferably utilizes a direct mapping of a net's identification number to an address in memory within the net engine. This mapping uses part or all of the identification number to determine the starting address in memory. Information about the fanout quantity is stored in the first location. All subsequent sequential addresses are used to store identifiers for the specified net. Thus, a one to many relationship is achieved and performance of a net event to multiple gate events is as little as four to eight clock cycles. If wire interference is modeled, then each net would have a list of other wires that influence the net's performance. This list of wires would be stored in a similar fashion but potentially in another memory bank so as to increase performance and simplicity.

A wire could also be modeled to have an effect on the environment of other wires and thus each wire within a particular range of the active net would have to have its information updated. In such a model, the change in the active net's state would have changed the other wires' environment in some manner and thus change their characteristics for transmitting data. Processing such data would require only four to eight clock cycle to read the affected nets and write back the changes to that net's environment. The actual performance of the calculation would be dependent on the model used but could be as fast as a few cycles if implemented directly in hardware. As with the logic engine and memory engine, pipelining and dual-ported memory can be utilized to increase the throughput performance of this influence to one net per one or two cycles.

For a distributed capacitive model, the network of wires between a gate's output and a number of gates' input are modeled with multiple delays, one per output to input path. For such a model, the net engine should receive the pending net events and translate them into pending gate events. FIG. 9B shows how each simulation engine's future event queue may be directly connected to the net engine. The net engine receives a net event from a particular simulation engine from a particular gate's output and for each destination input, the net engine determines the additional delay value that should be added to the intrinsic delay of the gate generating the net event. These two values are added together along with other delay factors, such as inductance and capacitance from surrounding wires. The result is a future gate event that is sent to the scheduler and then, at the appropriate time schedule, the gate event is sent out as a pending event.

In order to support both lumped and distributed capacitance models, there may be input and output communication channels between the scheduler and the simulation engines and between the net engine and the simulation engines. In essence, the communication channels of FIG. 9A and FIG. 9B are kept and another communication channel between the net engine and the schedule is added in both directions. This enables either model, or derivations of these models, to be utilized within the simulation platform.

Scheduler

As stated above, the main function of the scheduler is to receive future events from each of the simulation engines and sort them into chronological order. The scheduler also keeps track of a “virtual time” or “simulation time” that represents a moment in time during the simulation process. The scheduler increments the simulation time by a small time period (e.g., 1 picosecond), and all of the events stored in the scheduler that are time stamped to be evaluated during that time period are sent out to the various simulation engines. Therefore, the key to speed and efficiency in the scheduler is to sort the incoming events as they are received, rather than storing a group of events and then sorting them in a subsequent process. Generally, this sort-on-the-fly scheme is know as an insertion sort.

The scheduler may constantly receive future events, or there may be a “GVT” (Global Virtual Time) cycle that the simulation system progresses through. For example, the scheduler may increment GVT, find and serve out pending events to the engines, receive all future events from the engines, and then start a new cycle upon synchronization with all of the engines. The scheduler may also be capable of sending pending events to the simulation engines before the future event queues are empty (as described above).

The pending event for the logic simulation engine would include the model-ID, the input pin which changed state. Everything else can be looked up in the engine. Timing is reserved for the scheduler. For a future event, the future event queue would include the model-ID, a change in state, and identification of which output changed.

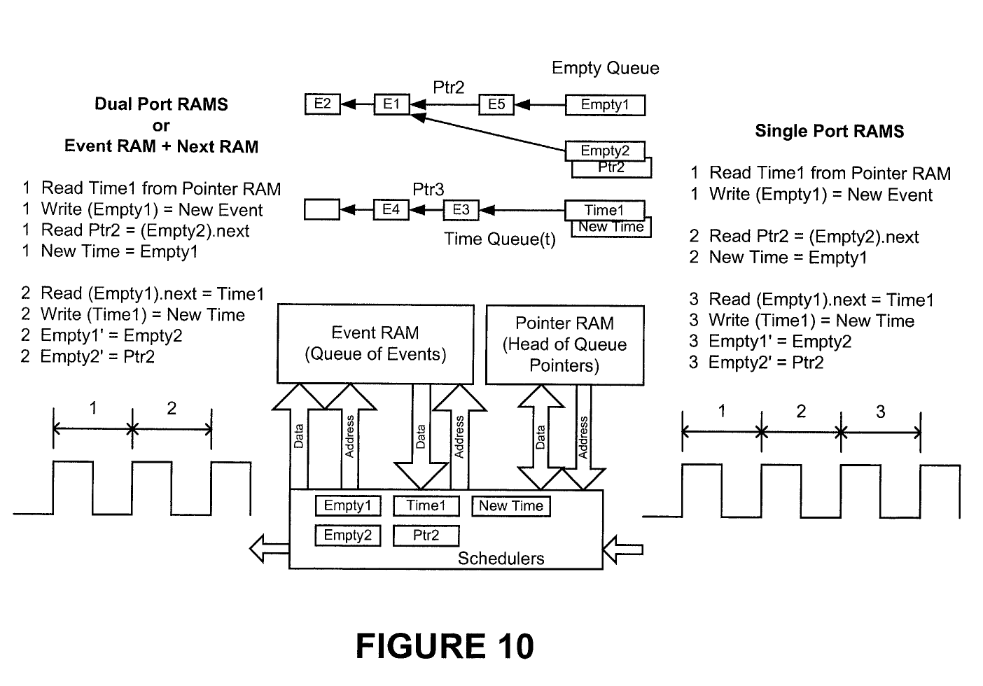

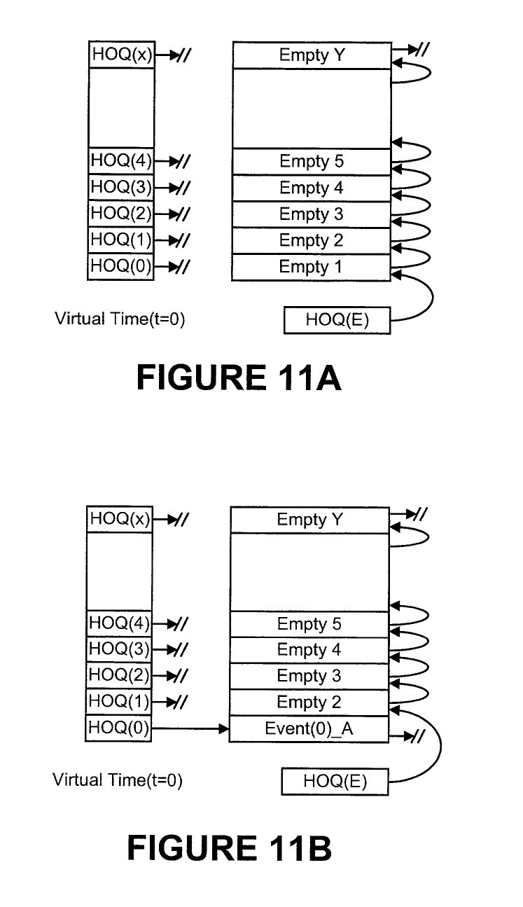

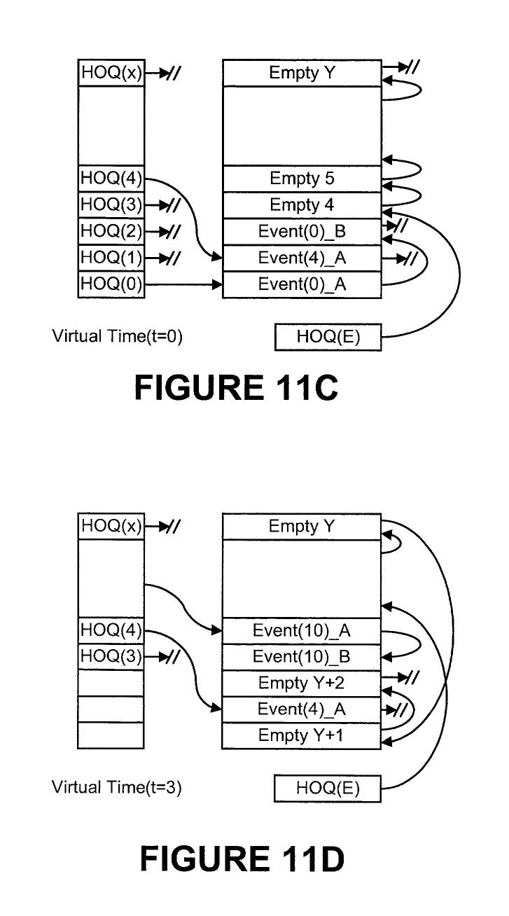

FIG. 10 shows a block diagram of one exemplary scheduler with timing for use with the present invention, and FIGS. 11A-11D detail actual data movement through the scheduler memories during sorting. The FIG. 10 scheduler generally includes two Random Access Memories (RAMs) labeled “Pointer Ram” and “Event RAM.” The Pointer RAM is used to keep track of the order of each received and stored event. The Event RAM is the actual storage space for the event. In FIG. 10, the Event RAM is further divided into a “data” RAM and a “next” RAM.

As depicted in FIG. 11A, the scheduler includes a list of pointers (labeled Head of Queue or “HOQ”) that point to the locations of future events within a certain time stamp. For example, all of the events with a time stamp from 0 to 1 picosecond in the future will be referenced in a queue of pointers starting with HOQ(0). All of the events with a time stamp from 1 to 2 picoseconds in the future will be referenced in a queue of pointers starting with HOQ (1), and so on. Therefore, to locate all events that are scheduled to be evaluated in a certain period, one can find the head of queue pointer for that period and follow its list of pointers to determine the addresses of all of the stored events. Initially, it is assumed that no events are stored in any queue, so all queues point to the null set (“//”). When the scheduler confirms that all events for the next time period have been inserted into the appropriate queue (e.g., HOQ(0)), those events can be released as pending events to the appropriate simulation engine.

The data is stored in a large continuous memory that is initially empty (the empty queue). A Head of Empty Queue (HOQ(E)) pointer will point to the first empty space in memory, and each space will then point to the next successive empty space. Initially, the entire memory is empty as is shown in FIG. 11A. These “empty” spaces are filled with incoming, time-stamped future events as they are received from the future event queues of each simulation engine. Rather than sorting all of the future events so that they exist in memory chronologically, the preferred embodiment of the present invention inserts each incoming future event into the next empty data space and keeps track of the chronological order through the use of the HOQ pointer queues.

To put it in terms of FIG. 10, the pointer RAM comprises a list of head of queue pointers for each instant of time. For example, assuming virtual time is at t=0 picoseconds, and our smallest granularity is a single picosecond, then the second head of queue pointer would point to the queue of events to be evaluated at time t=1 picosecond, the third head of queue pointer would point to the queue of events to be evaluated to time t=2 picoseconds, and so on. As the scheduler evaluates the time stamp of all received events, the scheduler determines which event queue includes the time stamp for the incoming event and inserts the event into that list.

The memory can be used efficiently by utilizing pointers rather than predefined blocks of memory. For example, assume a first time-stamped future event is received with a time stamp within 1 picosecond of the current simulation (virtual) time. This event will be stored in the first empty space in memory which is indicated by the HOQ(E) pointer. Because this is the first received event with a time stamp of t=0, it is shown as Event(0)_A and is inserted at the head of the empty queue (first available position) in FIG. 11B.

Now, the pointers must be updated to reflect that this space in memory is no longer “empty,” and the event must be placed in its appropriate time queue. First, the empty queue pointer is updated to point to the previous second member (Empty2) of the empty queue (FIG. 11B) which will still point to the next empty space (which is now the second empty space in the empty queue) and so on.

Likewise the pointers for Event(0)_A must be updated. The scheduler locates the correct event queue into which the received event should be inserted by directly mapping the event to its queue based on the time stamp of the received event plus the GVT. In this case, the received event had a time stamp of t=0 picoseconds, and it would be inserted into the first event queue (HOQ(0)). Since this queue has no other events in it, the HOQ(0) pointer is updated to directly point to Event(0)_A. Event(0)_A is updated to point to the null set because it is the current end of the HOQ(0) queue. If the HOQ(0) event queue already included other events, the head of queue pointer would point to the first entry in the queue, the first entry would point to the second entry, and so on. To put the currently received event into this list, the last existing element in the queue would be updated to point to the newly stored Event(0)_A (which would now be the last event in the queue).

Turning to FIG. 11C, as the next event (Event(4)_A) is received from the simulation engines, it will be stored in the next available (empty) space in the data RAM. In the same way as just described, the head of empty queue pointer HOQ(E) will be updated to point to the next empty space Empty3 because Empty2 is no longer empty. The scheduler will also determine, based on the received event's time stamp and GVT, into which event queue the newly received event should be placed (HOQ(4)) and terminate this queue with the null set. In this way, each received event can be inserted into the proper event queue as they are received, with no sorting step that necessitates a stopping of processing.

FIG. 11C also shows that a third event, Event(0)_B, has been received after Event(4)_A. Since Event(0)_B is the second received event in the HOQ(0) queue, it will be placed in that queue at the end (after Event(0)_A) and will terminated with a null set. The HOQ(E) empty set pointer is again updated to move to the next empty space Empty4.

Once the scheduler determines that all of the events in the next virtual time increment (after the present time) have been inserted into the proper event queue, the virtual time can be incremented, e.g., by 1 picosecond, and all events in that queue can be released to the simulation engines for evaluation. In the present example, all of the elements referenced in the HOQ(0) queue would be released next. Because all of the pending events scheduled for the current picosecond of virtual time are in a linked list, they can be sent one after another to the intended simulation engines. In this way, only events that can be immediately evaluated are sent to the simulation engines, so the simulation engines can evaluate every event that is sent to them, as soon as it arrives.

According to this algorithm and as shown in FIG. 10, the scheduler may be capable of performing this sorting function in only two or three clock cycles if the above-described hardware components are used. The Event and Pointer RAMs may be either single or dual ported. If dual ported, the RAM may be read from and written to simultaneously, rather than only performing one operation at a time. Also, if the Event RAM is constructed so as to be wide enough to hold an entire event, e.g., 128 or 144 bits wide, than a single read and write operation will allow an entire event to be manipulated, rather than the multiple read/write cycles needed if a conventional width memory is used.

If the amount of data space was unlimited, then a data queue for every picosecond period until the end of time could reside in the memory. However, actual space is limited by physical constraints, and searching such a long memory to determine into which queue to insert the received event would take too long. Therefore, a timing wheel-type approach can be used to alleviate this problem. With the timing wheel approach, the virtual time periods that are closest to the present time are sorted with the finest granularity available, and this granularity will be rougher as the time-stamped events are designated to be evaluated further in the future.

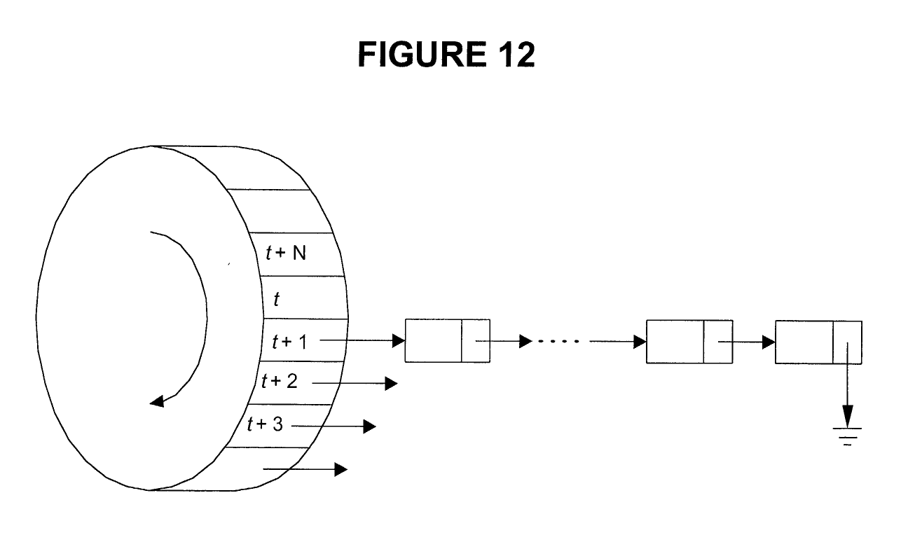

As a simplified example, assume there are three timing queues (timing wheels) of varying granularity that can each hold 100 entries (see generally, FIG. 12). The first wheel would include the head of queue pointers for time t=0, t=1, all the way to time t=99. If an event is received and the time stamp is 15 picoseconds in the future, this event would be added (with pointers) to the queue representing time t=15 (the 16th queue). The second timing wheel would be an order of magnitude (in this case 100 times) larger than this fine granularity timing wheel. The first entry in the second timing wheel would include all events with a time stamp between 100 and 199 picoseconds in the future. The second entry would include all events with a time stamp between 200 and 299 picoseconds, and the final entry in this timing wheel would include events with a time stamp between 10,000 and 10,099 picoseconds. Again, these events can be “stored” in the timing wheel using a linked list of data pointers for each timing wheel location.

The third timing wheel would be an additional factor removed. Therefore, the first entry in the third timing wheel would include all events with a time stamp between 10,100 and 1 million picoseconds. Each successive entry in the third wheel would include an additional 1 million picoseconds of time.

Because multiple timing wheels are used, there must also be a mechanism to move the information from the lower resolution timing wheels to the higher resolution (1 picosecond) timing wheel. Therefore, at or near the time when virtual time is incremented to the last entry in the first timing wheel (e.g., t=99 picoseconds), all of the events from the first entry in the second timing wheel (e.g., t=100-199 picoseconds) are taken out of the second timing wheel and inserted into the first timing wheel into the appropriate division.

This process is enabled by adding a “rollover” function to the timing wheels and timing queues. In essence, the wheels are used as a continuously updating circle of time, rather than a discrete group of 100 picoseconds. More specifically, as time is incremented from t=0 to t=1, t=2, etc., the HOQ(0), HOQ(1), and HOQ(2) entries of the first timing wheel become empty. To aid in the future sorting of incoming events, when the virtual time is incremented (so that the timing wheel now only goes from t=1 to t=99, the space where t=0 formerly existed (before these events were released to the simulation engines), can now be made t=100 (HOQ(100)). When virtual time is incremented again, the former t=1 can now be made into t=101 (HOQ(101)). In this way, the first timing wheel can always represent the next 100 picoseconds (or any number depending on memory size), rather than a predefined 100 picosecond period. When the entries from the second timing wheel are sorted into the first timing wheel, some of the entries in the first timing wheel may be partially filled because incoming events were directly sorted therein. The other timing wheels could also use this rollback feature to always stay some unit of time (e.g., 1 million picoseconds) in the future.

FIG. 11D shows one exemplary set of scheduler data after virtual time has been incremented several times. As seen in this figure, the HOQ(0) events have been released to the simulation engines, so the data entries which used to hold Event(0)_A and Event(0)_B are now part of the empty queue. These empty data spaces are added to the empty queue by altering the final empty queue pointer (from Empty Y) so that it points to the new Empty Y+1 which in turn points to Empty Y+2. Also shown in FIG. 11D is a case in which two events to be evaluated at time t=10 are stored in memory in the reverse order in which they were received (first Event(1)_B, then Event(10)_B). Because of the cyclical reuse of memory space, this occurrence is not uncommon.

Although this example described three timing wheels of 100 entries, any number of wheels with any number of entries could be used. For example, with computational circuits that deal with binary data, it is often easier to use sizes that are a power of 2, such as 1024 for a kilobyte, rather than using a decimal number such as 1000. All alternatives are meant to be encompassed by the teachings herein and FIG. 12 uses “N” to represent this.

Although the event scheduler and its sorting functions may take many forms, additional information about one preferred embodiment using the concept of Global Virtual Time (GVT) will now be given. Incrementing GVT is a critical part of the scheduler when the scheduler is optimized for peak performance as described above. For example, GVT may be incremented when all of the pending events have been calculated and the future events are placed into the scheduler. GVT is advanced to the next time slot that contains an event. However, for a high-fidelity simulator, there may be many time increments that do not have an event associated with them. Thus, it is inefficient to sequentially increment GVT by a single time quantum and continue to do so until a scheduled event is found.

As discussed above, the HOQ RAM contains pointers to queues for a particular time slot. If HOQ[i] is null, then there is no event for time i. This inefficiency can be addressed by defining a bit-vector called the Time Vector (TV) that is an array of bits such that TVO[i]=‘1’ if a future event exists at time i. Incrementing GVT is then reduced to finding the smallest i such that no j exists such that i>j and TV0[j]=‘1’ and TV0[j]=‘1’. If TVO has a length of 128 bits then a simple combinational circuit, min_i( ) can be devised to determine i. If 128 such TV0 vectors are defined, together they represent 128*128 time slots. ATV1 is defined to be a bit vector of equal length as TV0, and TV1[k]=‘1’ if there exists any j in the kth TV0 vector such that TV0[j]=‘1’. By examining each entry in TV1, GVT can be incremented by 128 time increments per cycle when no events are scheduled in the next 128 picoseconds (supposing a time quantum is 1 picoseconds).

If there are only 128*128 time slots then the exact minimum time that contains a future event can be determined in two steps and a similar number of clock cycles. First, an examination of TV1 is made using i=min_i(TV1). Supposing that min_i( ) returns a binary number I, then GVT could be incremented by (i−1)*128 increments. This is the coarse tuning of the timing wheel. The ith TV0 is then read in and i is redefined as min_i(TV0). Fine tuning of the timing wheel is accomplished by incrementing GVT by j.

This algorithm can be expanded to any number of levels of granularity to increase the number of time slots to be equal to the size of HOQ. The width of TV is that of memory so that TV can be read within a single memory access cycle. Each level of granularity requires only 128 additional bit vectors and a single memory read of 128 bits. However, each additional level of granularity adds two orders of magnitude of capacity for the number of time increments possible. Thus, for four levels of granularity with 256 bit wide memory, 4 billion time slots are available.

When removing events from the schedule, the bit vectors are updated to reflect the absence of the events and thus, the algorithm doesn't change after events are removed from the schedule.

When events are placed into the schedule, the TV vectors are updated while the event data is being placed into the scheduler's RAM. The vast majority of events will be scheduled within a predictable range of time and thus, the expected performance is only a few cycles to also update the TV vectors concurrently with inserting the future event. By doing this, the overhead of maintaining the TV vectors is additional hardware but not additional time as time is already being spent performing the future event insertion operation.

The present invention may be applied to various real-world discrete event systems to facilitate improved design characteristics. For example, the time to market in consumer electronics is critical to success. Therefore, reducing the design cycle is also critical. As previously described, each level of the design cycle increases the accuracy of the results but also increases the amount of time needed to achieve the results. However, if the design is not fully verified at each level of the design cycle, errors will propagate to the next level, and the design cycle time will increase. If a timing glitch is not found using the processes of the present invention before fabrication, a long process of re-simulation, fabrication and testing will ultimately ensue. Therefore, post place-and-route simulation, which is facilitated by the present invention, is important.

The present invention can also improve the power consumption and fault monitoring testing of digital circuits. The power consumption in consumer electronics is important not only to battery operation but also to determine the heat characteristics of the chip. Because post place-and-route heat testing is time consuming, it is preferably to determine these heat characteristics during simulation. The present invention is preferably capable of counting the number state changes for each part of the circuit to determine such characteristics.

Another motivation for the current invention is to simulate Intellectual Property blocks (IP blocks) for system-on-a-chip (SOC) fabrication. With SOC, the entire digital circuit system exists on one single integrated circuit chip, as opposed to be spread across an entire circuit board. Although SOC technology is important in that it allows electronics to shrink in size and power consumption, it presents new difficulties because the single chip design can not be “rewired” during a testing process as elements on a circuit board can. Also, the interior regions of a chip, as opposed to a printed circuit board, can not be probed to determine potential errors during testing. Therefore, accurate simulation before the testing and fabrication of the circuit may be more important than with traditional fabrication technologies.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A discrete event simulator comprising:
an event scheduler for sorting incoming future events; and
at least one simulation engine for evaluating pending events, said at least one simulation engine being remote from said scheduler but being communicatively connected thereto.

2. The discrete event simulator of claim 1, wherein said at least one simulation engine is capable evaluating pending events which include a model core selected from the group consisting of a truth table, a lookup, a reduction to finite conclusion of a continuous or transient equation, a re-programmable core-processor, a software emulated core within the model, and a hardware emulated core.

3. The discrete event simulator of claim 1, wherein said at least one simulation engine comprises a logic simulation engine.

4. The discrete event simulator of claim 1, wherein said at least one simulation engine comprises a memory simulation engine.

5. The discrete event simulator of claim 1, wherein said at least one simulation engine comprises a software simulation engine.

6. The discrete event simulator of claim 1, wherein said at least one simulation engine comprises an interconnections simulation engine.

7. The discrete event simulator of claim 1, wherein said at least one simulation engine comprises more than one simulation engines, further wherein each of said more than one simulation engines is directly connected to the event scheduler.

8. The discrete event simulator of claim 7, wherein each of said more than one simulation engines is selected from the group consisting of a logic engine, a memory engine, a software engine, an interconnection engine, and subsets of the above engines.

9. The discrete event simulator of claim 7, wherein at least two of said more than one simulation engines are of the same type.

10. The discrete event simulator of claim 1, further comprising:
at least one pending event queue directly connecting the scheduler to said at least one simulation engine; and
at least one future event queue directly connecting said at least one simulation engine to said scheduler.

11. The discrete event simulator of claim 10, wherein said pending event and said future event queues are conventional computer bus structures.

12. The discrete event simulator of claim 10, wherein said pending event and said future event queues are point-to-point connections between the scheduler and each of said at least one simulation engines.

13. The discrete event simulator of claim 12, wherein said point-to-point connections are gigabit conduits.

14. The discrete event simulator of claim 1, wherein said scheduler comprises at least one timing wheel.

15. The discrete event simulator of claim 1, wherein said scheduler comprises at least two timing wheels.

16. The discrete event simulator of claim 1, wherein said scheduler further comprises:
an event RAM for holding a queue of received events; and
a pointer RAM for holding head of queue pointers which point to the first element in a queue of events for each simulation time period.

17. The discrete event simulator of claim 16, wherein said event RAM and said pointer RAM are dual ported.

18. The discrete event simulator of claim 16, wherein said event RAM includes a data RAM and a next event RAM.

19. The discrete event simulator of claim 16, wherein said event RAM is wide enough to read/write an entire event in one clock cycle.

20. The discrete event simulator of claim 19, wherein said event RAM is 144 bits wide.

21. The discrete event simulator of claim 16, wherein said event RAM includes rollover functionality to reuse memory locations that have already had their data released as pending events to the simulation engine.

22. The discrete event simulator of claim 16, wherein said event scheduler utilizes a global virtual time to keep track of simulation time and release all pending events at one time.

23. The discrete event simulator of claim 1, wherein at least one of said at least one simulation engines comprises a pipelined structure such that an incoming event can be evaluated each clock cycle.

24. The discrete event simulator of claim 1, wherein said at least one simulation engine is adapted to simulate the intrinsic delay within each structure being simulated.

25. The discrete event simulator of claim 1, wherein said at least one simulation engine is adapted to simulate the extrinsic delay due to output load for each structure being simulated.

26. The discrete event simulator of claim 1, wherein said at least one simulation engine is adapted to simulate the wire delay between each structure being simulated.

27. The discrete event simulator of claim 1, further comprising:
a net-list engine communicatively coupled to said event scheduler, wherein said net-list engine is capable of generating additional events that account for the capacitive effects caused by having multiple discrete event elements connected to a single output of a first discrete event element.

28. The discrete event simulator of claim 27, wherein said net-list engine is located between an output queue of said simulation engine and said event scheduler.

29. The discrete event simulator of claim 27, wherein said net-list engine is located between said event scheduler and an input queue of said simulation engine.

30. The discrete event simulator of claim 27, wherein said net-list engine is directly connected to said event scheduler and is in parallel with said at least one simulation engine.

31. The discrete event simulator of claim 1, further comprising:
a host workstation communicatively coupled to said event scheduler and said at least one simulation engine.

32. The discrete event simulator of claim 31, wherein said host workstation is capable of altering the setup of the discrete system being simulated while the simulation is running.

33. The discrete event simulator of claim 31, wherein said host computer is adapted to receive future events to analyze the system being simulated for runtime errors.

34. The discrete event simulator of claim 4, wherein said memory simulation engine comprises:
a data storage RAM/CAM;
emulation logic; and
a configuration RAM.

35. The discrete event simulator of claim 1, wherein elements of a discrete event system to be simulated are represented using a universal device primitive.

36. A discrete logic simulator, comprising:
an event scheduler for sorting incoming future events;
at least one simulation engine for evaluating pending events, said at least one simulation engine being remote from said scheduler but being communicatively connected thereto;
at least one pending event queue directly connecting the scheduler to said at least one simulation engine;
at least one future event queue directly connecting said at least one simulation engine to said scheduler; and
a host workstation communicatively coupled to said event scheduler and said at least one simulation engine.

37. The discrete logic simulator of claim 36, wherein said at least one simulation engine is capable evaluating pending events which include a model core selected from the group consisting of a truth table, a lookup, a reduction to finite conclusion of a continuous or transient equation, a re-programmable core-processor, a software emulated core within the model, and a hardware emulated core.

38. An event scheduler for use with a discrete event simulator, comprising:
an event RAM for holding a queue of received events; and
a pointer RAM for holding head of queue pointers which point to the first element in a queue of events for each simulation time period.

39. The event scheduler of claim 38, wherein said event RAM is partitioned into a data RAM and a next RAM.

40. A method for simulating a system of discrete events, comprising the steps of:
loading a discrete event system to be simulated into at least one simulation engine for evaluating pending events and creating future events to be evaluated at a later time;
loading initial conditions into said at least one simulation engine and an event scheduler remote from said simulation engine capable of sorting said future events;
starting said simulation; and
receiving results of said simulation.

41. The method of claim 40, wherein each of these steps is facilitated by a host computer communicatively connected to said event scheduler and said at least one simulation engine.

42. The method of claim 40, wherein said at least one simulation engine comprises more than one simulation engines, further wherein each of said more than one simulation engines is directly connected to the event scheduler.

43. The method of claim 42, wherein each of said more than one simulation engines is selected from the group consisting of a logic engine, a memory engine, a software engine, an interconnection engine, and subsets of the above engines.

44. The method of claim 40, wherein said scheduler further comprises:
an event RAM for holding a queue of received events; and
a pointer RAM for holding head of queue pointers which point to the first element in a queue of events for each simulation time period.

45. The method of claim 40, wherein said first loading step includes storing representations of elements of the system of discrete events using universal device primitives.

46. A method for sorting and scheduling events in a discrete event simulator, comprising the steps of:
receiving a future event from one of at least one remote simulation engines, said event including a time stamp defining at what time in the future the event is to be evaluated by one of said remote simulation engines;
inserting said future event into an empty memory location indicated by a head of empty queue pointer; and
updating a head of queue pointer for a time period corresponding to the time stamp of the future event to add the future event into a queue of events to be evaluated at said time period.

47. The method of claim 46, wherein simulation time is controlled using a global virtual time.

48. The method of claim 47, further comprising the steps of:
incrementing said global virtual time; and
releasing a queue of saved events as pending events to one of said remote simulation engines, wherein said queue is indicated by a head of queue pointer for the time period matching the incremented global virtual time.

49. The method of claim 48, further comprising the step of:
generating a plurality of gate events based on at least one of said sent pending events to account for capacitive effects of element fanout in said discrete event system.

50. The method of claim 46, further comprising the step of:
generating a plurality of future events responsive to the capacitive effects of element fanout in said discrete event system, wherein said plurality of future events are based on a single event from one of said remote simulation engines.
